(19) United States
(12) Patent Application Publication
(10) Pub. No.: US 2025/0200852 A1
(43) Pub. Date: Jun. 19, 2025

(54) COMMUNICATION SYSTEM, INFORMATION PROCESSING APPARATUS, TERMINAL DEVICE, AND INFORMATION PROCESSING METHOD

(71) Applicants: Yuuki SUZUKI, Kanagawa (JP); Eri WATANABE, Tokyo (JP); Hiroaki TANAKA, Tokyo (JP); Terunori KOYAMA, Tokyo (JP); Kohei MARUMOTO, Tokyo (JP); Takuroh NAITOH, Tokyo (JP); Yuki HORI, Aichi (JP)

(72) Inventors: Yuuki SUZUKI, Kanagawa (JP); Eri WATANABE, Tokyo (JP); Hiroaki TANAKA, Tokyo (JP); Terunori KOYAMA, Tokyo (JP); Kohei MARUMOTO, Tokyo (JP); Takuroh NAITOH, Tokyo (JP); Yuki HORI, Aichi (JP)

(21) Appl. No.: 18/982,294

(22) Filed: Dec. 16, 2024

(30) Foreign Application Priority Data
Dec. 18, 2023 (JP) 2023-213337
Aug. 30, 2024 (JP) 2024-148305

(51) Int. Cl. G06T 11/60; G06F 3/04845; G10L 15/183; G10L 15/30

(52) U.S. Cl. CPC G06T 11/60; G06F 3/04845; G10L 15/183; G10L 15/30; G06T 2200/24

(57) ABSTRACT

A communication system includes a terminal device and an information processing apparatus. The terminal device includes terminal circuitry to display language information based on information input to the terminal device in a first area of an information display screen of the terminal device in a time series. The information processing apparatus communicates with the terminal device via a network. The information processing apparatus includes server circuitry to acquire analysis information. The analysis information includes information generated by analyzing language information present in a designated range of the language information based on the information input to the terminal device. The terminal circuitry displays the analysis information acquired from the information processing apparatus in a second area of the information display screen.

### CROSS-REFERENCE TO RELATED APPLICATIONS

This patent application is based on and claims priority pursuant to 35 U.S.C. § 119 (a) to Japanese Patent Application No. 2023-213337, filed on Dec. 18, 2023, and No. 2024-148305 filed on Aug. 30, 2024, in the Japan Patent Office, the entire disclosure of which are hereby incorporated by reference herein.

### BACKGROUND

### Technical Field

The present disclosure relates to a communication system, an information processing apparatus, a terminal device, and an information processing method.

### Related Art

In communication such as a conference, a facilitator may write speeches of participants of the conference on a whiteboard and visualize language information to share the content of discussion. The participants of the conference extracts and transcribes important keywords or encloses the keywords with frames. In order to support the work on the whiteboard, a technique is known in which the speeches of the participants of the conference are converted into language information by voice recognition and is displayed.

A technique for utilizing the language information acquired by voice recognition has been proposed. A display control system has been proposed that extracts a keyword from language information acquired by converting a speech of a participant into text, executes search processing on data based on the extracted keyword, and displays the language information searched by the search processing and a search result including an image in different display areas.

### SUMMARY

Embodiments of the present disclosure described herein provide a novel communication system including a terminal device and an information processing apparatus. The terminal device includes terminal circuitry to display language information based on information input to the terminal device in a first area of an information display screen of the terminal device in a time series. The information processing apparatus communicates with the terminal device via a network. The information processing apparatus includes server circuitry to acquire analysis information. The analysis information includes information generated by analyzing language information present in a designated range of the language information based on the information input to the terminal device. The terminal circuitry displays the analysis information acquired from the information processing apparatus in a second area of the information display screen.

Embodiments of the present disclosure described herein provide a novel information processing apparatus communicably connected with one or more terminal devices. The information processing apparatus includes terminal circuitry. The terminal circuitry receives information related to language information based on information input to the terminal device. The terminal circuitry acquires analysis information generated by analyzing the language information. The terminal circuitry transmits, to the terminal device, the language information to be displayed in a time series in a first area of a screen displayed by the terminal device and the analysis information to be displayed in a second area of the screen.

Embodiments of the present disclosure described herein provide a novel information processing method. The method includes: displaying language information based on information input to a terminal device in a first area of an information display screen of the terminal device in a time series; with an information processing apparatus communicably connected with the terminal device, acquiring analysis information, the analysis information including information generated by analyzing language information present in a designated range of the language information based on the information input to the terminal device; and displaying the analysis information in a second area of the information display screen.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an information display screen displayed by a terminal device during a conference;

FIG. 2 is a diagram illustrating a system configuration of a communication system;

FIG. 3 is a diagram illustrating a hardware configuration of a terminal device and an information processing apparatus;

FIG. 4 is a functional block diagram of a communication system in which functions are separately illustrated as blocks in an information processing apparatus and a terminal device;

FIG. 5 is a conceptual diagram illustrating a conversation content table;

FIG. 6 is a conceptual diagram illustrating a content table;

FIG. 7 is a conceptual diagram illustrating an illustration table;

FIG. 8 is a conceptual diagram illustrating a conference management table;

FIG. 9 is a conceptual diagram illustrating an arrangement information table;

FIG. 10 is another conceptual diagram illustrating an arrangement information table;

FIG. 11 is a conceptual diagram illustrating a content display time-series table;

FIG. 12 is a diagram illustrating an information display screen in an initial state displayed by a terminal device;

FIG. 13 is a diagram illustrating a first setting screen and a second setting screen displayed when a generative artificial intelligence (AI) setting button is pressed;

FIG. 14 is an enlarged view of a first setting screen;

FIG. 15 is an enlarged view of a second setting screen;

FIG. 16 is a sequence diagram illustrating a process in which a terminal device transmits voice data to an information processing apparatus and the information processing apparatus shares language information converted from the voice data with other terminal devices;

FIG. 17 is a sequence diagram illustrating a process in which terminal devices display analysis information generated by analyzing language information by a generative AI system in a whiteboard work area;

FIG. 18 is a diagram illustrating an arrangement of analysis information displayed by the terminal device;

FIG. 19 is a diagram illustrating an area in which analysis information is arranged;

FIG. 20 is a diagram illustrating an illustration displayed together with the analysis information in a whiteboard work area;

FIG. 21 is a functional block diagram of an arrangement information output unit using machine learning;

FIGS. 22A to 22D are schematic diagrams illustrating a process in which a terminal device displays an illustration based on language information in a conversation accumulation area;

FIGS. 23A and 23B are diagrams illustrating display orders of thumbnails of illustrations determined in accordance with language information;

FIG. 24 is a diagram illustrating an information display screen including a temporary area, which is displayed by a terminal device during a conference;

FIG. 25 is a diagram illustrating an information display screen on which an illustration list is displayed in a temporary area;

FIG. 26 is a sequence diagram of a process in which a terminal device copies analysis information from a temporary area to a whiteboard work area in response to an operation by a participant;

FIG. 27 is a diagram illustrating a hardware block diagram of a head-mounted display (HMD);

FIG. 28 is a functional block diagram of a communication system in which functions are separately illustrated as blocks in an information processing apparatus and a terminal device;

FIG. 29 is a schematic diagram illustrating an AI analysis result stored in an AI analysis result storage unit;

FIG. 30 is a diagram illustrating a part of an AI analysis area;

FIG. 31 is a diagram illustrating an AI analysis result displayed in the AI analysis area of FIG. 30;

FIG. 32 is a diagram illustrating the AI analysis area of FIG. 30 in which multiple major items are displayed;

FIG. 33 is a diagram illustrating a major item and key sentences;

FIG. 34 is a diagram illustrating a major item and key sentences displayed in a whiteboard work area by pressing an arrangement button;

FIG. 35 is a diagram illustrating a whiteboard work area in which multiple frames are displayed;

FIG. 36 is a diagram illustrating a whiteboard work area in which frames are displayed in different modes according to combinations of major items and one or more key sentences;

FIG. 37 is a diagram illustrating a selection screen of a content arrangement template;

FIG. 38 is a diagram illustrating a content arrangement template displayed in a whiteboard work area;

FIG. 39 is a sequence diagram illustrating a process of displaying an AI analysis result generated by analyzing language information by a generative AI system in an AI analysis area;

FIG. 40 is a sequence diagram illustrating a process in which terminal devices display a major item and a key sentence in a whiteboard work area;

FIG. 41 is a sequence diagram illustrating a process of displaying a content arrangement template by terminal devices; and

FIG. 42 is a sequence diagram illustrating a process in which terminal devices display an AI analysis result generated by a generative AI system analyzing language information in an AI analysis area after the end of a conference.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of a communication system and an information processing method performed by the communication system with reference to the drawings.

In a scene of communication, it is known that efficient and accurate information transmission is possible when visual information such as an illustration or an icon is added to language information. For example, in a conference where new projects and ideas are discussed, the use of visual information is effective for communicating with multiple participants. In order to perform communication using visual information more efficiently, a whiteboard application is known which allows multiple participants to perform collaborative editing online.

For example, a first online whiteboard service provided on the web is known. The first online whiteboard service provides a service in which a web application displays text data, which is referred to as a talk log, in a history area in real time. The text data includes a voice recognition result and a keyboard input result input by a participant of a conference. The web application also displays an online whiteboard screen that is referred to as a workspace. The participants of the conference can press or drag the text data of the talk log to arrange the text data on the online whiteboard screen of the workspace and thus, the participants of the conference can perform collaborative editing online while visualizing the process of communication.

However, in the first online whiteboard service, in order to arrange text data of a talk log of the participants of a conference on the online whiteboard screen of the workspace, the participant is needed to perform a manual operation of pressing or dragging the text data of the talk log. For example, in a conference in which active discussions are held (i.e., the talk log is scrolled quickly), it is difficult for the participants of the conference to extract useful information from the talk log, and the participants need to be accustomed to use the first online whiteboard service. Even a participant who is accustomed to use the first online whiteboard service is forced to be conscious of the extraction of the remark from the talk log and thus, the participant is not likely to concentrate on the discussion of the conference.

A second online whiteboard service having an assist function using AI is also known. When a participant of a conference selects the text input to a whiteboard and executes the assist function, the assist function provides functions such as adding a similar idea proposed by a generative AI to the whiteboard, selecting multiple pieces of information to create a summary, and generating an image associated with the selected text.

However, the second online whiteboard service requests the participant of the conference a manual operation to select text data.

As described above, in such services, the intervention of the participant is requested in order to extract useful information from the text data input by the participant. For example, ideas are not automatically collected from language information input in real time by participants participating in a conference.

The communication system according to the present embodiment automatically analyzes a designated range of language information based on information input during the process of communication, and automatically arranges the analysis result in a shared whiteboard work area. Since the range of the language information is designated, the information to be displayed can be limited. The participant can grasp only useful information. The communication system extracts ideas included in the communication and organizes the flow of discussions. As a result, the load of the participants in the communication can be reduced.

### First Embodiment

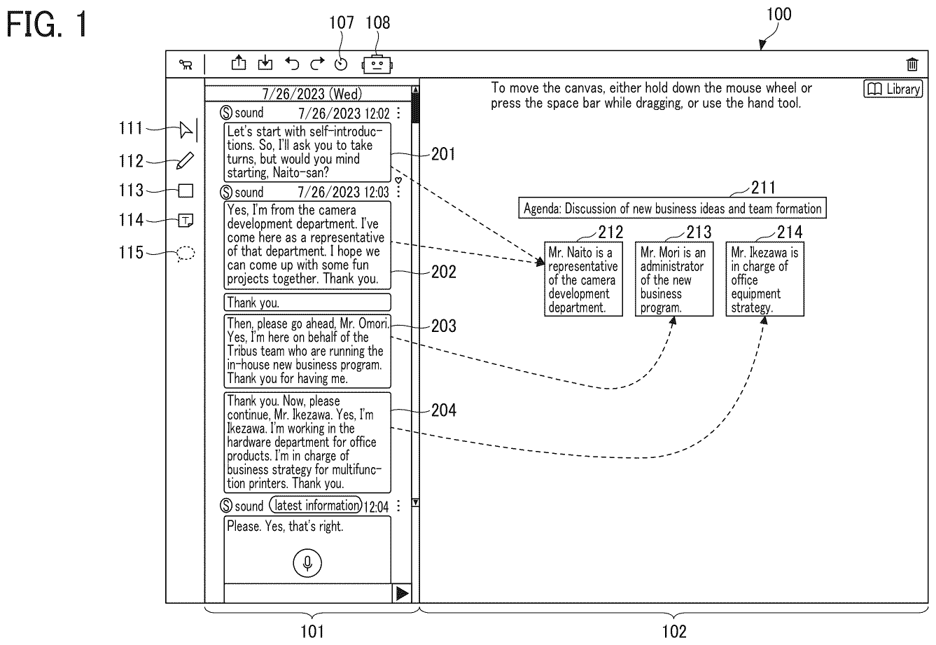

A description is given below of an outline of an operation of the communication system according to the present embodiment with reference to FIG. 1. FIG. 1 is a diagram illustrating an information display screen 100 displayed by a terminal device during a conference. As illustrated in FIG. 1, the information display screen 100 includes a conversation accumulation area 101 (a first area) and a whiteboard work area 102 (a second area). The conversation accumulation area 101 is an area in which language information and a history of language information are displayed. The language information is based on voice data acquired by converting the content of conversation between the participants of the conference by voice input and voice recognition and the history of language information is based on text data input through a keyboard by the participants of the conference. The whiteboard work area 102 is an area where the participant displays information based on the language information in the conversation accumulation area 101, handwritten data, directly input language information, or various images, as in a normal electronic whiteboard. The terminal device preferably includes a touch screen for inputting handwritten data, but may include a normal display. In this case, a participant who operates the terminal device (may be simply referred to as a participant in the following description) performs a handwriting input using a mouse.

A description is given below of language information 201 to 204 included in the conversation accumulation area 101. The language information 201 is “Let's start with self-introductions. So, I'1l ask you to take turns, but would you mind starting, Naito-san?” The language information 202 is “Yes, I'm from the camera development department. I've come here as a representative of that department. I hope we can come up with some fun projects together. Thank you.” The language information 203 is “Then, please go ahead, Mr. Omori. Yes, I'm here on behalf of the Tribus team who are running the in-house new business program. Thank you for having me.” The language information 204 is “Thank you. Now, please continue, Mr. Ikezawa. Yes, I'm Ikezawa. I'm working in the hardware department for office products. I'm in charge of business strategy for multifunction printers. Thank you.”

The information processing apparatus described below (automatically) analyzes the language information 201 to 204 without intervention of the participants of the conference. For example, a large-scale language model (LLM) may be used for the analysis. In FIG. 1, an agenda 211 of the language information 201 to 204 and topics 212 to 214 of the language information 201 to 204 are displayed in message boxes in the whiteboard work area 102. The message box is a display component in which characters are arranged. As described above, the information processing apparatus can automatically display the agenda 211 and the topics 212 to 214 from multiple pieces of language information 201 to 204 or language information 201 to 204 of different speakers.

The agenda 211 is a result of analyzing what topics are being discussed by analyzing the language information 201 to 204 using the LLM. The topics 212 to 214 are analysis results acquired by extracting topics on which discussions are made by analyzing the language information 201 to 204 in the LLM.

In FIG. 1, for the sake of convenience, arrows are displayed from the language information 201 to 204 to the corresponding topics 212 to 214. These arrows are not displayed (may be displayed) during actual use. As illustrated in FIG. 1, the topics 212 to 214 of the language information 201 to 204 are collected in the whiteboard work area 102. The information processing apparatus can apply the agenda 211 and the topics 212 to 214 to a hierarchical structure set in advance to display the three topics 212 to 214 arranged in parallel below the agenda 211. Accordingly, the participants can easily understand the relation between the agenda 211 and the topics 212 to 214.

The language information is information configured by a language such as Japanese or English. In the present embodiment, the language information includes not only information acquired by voice recognition of words spoken by a speaker but also information input from a keyboard. The language information includes information that can be displayed by a computer based on character codes such as characters, graphics, numerals, and alphabets.

When the language information is accumulated in time series, the language information is displayed in the order of the speech and any past language information can be browsed.

The analysis of the language information indicates generation of meaningful information based on the language information. In the present embodiment, the generated information is an analysis result, and is referred to as analysis information. The analysis information may be included in the language information. Alternatively, the analysis information may be acquired from the outside based on the language information. The analysis information may be conceptually narrow language information. Alternatively, the analysis information may include a concept that is not included in the language information. The analysis information may include not only language information but also graphics, images, and uniform resource locators (URLs) of web pages.

The work area is an area on the computer screen where the participant can edit the arrangement and contents of the language information and content. An example of the work area is an area that can be used as an electronic whiteboard. The electronic whiteboard is a device that can write handwritten data using a touch screen in the same manner as a general whiteboard, and can display a screen and data of a personal computer (PC). The electronic whiteboard may be referred to as an electronic blackboard, an electronic information board, or an electronic whiteboard.

The content is a display object displayed in the work area. The content may be any content that can be displayed on a computer and can be visually recognized by the participants, such as language information, illustrations, graphics, tables, screens and data of PCs, and information on the Internet. The analysis information displayed in the work area is also the content.

The analysis of the language information refers to generation of meaningful information based on the language information. In the present embodiment, the generated information is an analysis result, and is referred to as an AI analysis result. The AI analysis result may be included in the language information. Alternatively, the AI analysis result may be acquired from the outside based on the language information. The AI analysis result may be conceptually narrow language information. Alternatively, the AI analysis result may include a concept that is not included in the language information. The AI analysis result may include not only language information but also graphics, images, and uniform resource locators (URLs) of web pages. In the present embodiment, for example, one or more of a major item, a key sentence, an illustration, and a category are generated by analyzing the language information. Accordingly, the AI analysis result is one or more of the major item, the key sentence, the illustration, and the category.

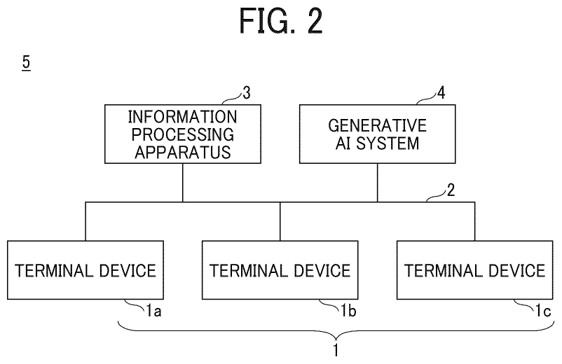

FIG. 2 is a diagram illustrating a system configuration of a communication system 5. The communication system 5 includes multiple terminal devices 1a to 1c and an information processing apparatus 3 that can communicate with each other via a network 2. In FIG. 2, the communication system 5 includes further a generative AI system 4 that is connected to the network 2. Any of the terminal devices 1a to 1c is referred to as a terminal device 1 or terminal devices 1. The terminal device 1 does not need to be connected to the network 2 at all times. The number of the terminal devices 1 is not limited to three, and two or more terminal devices 1 may be used for communication. Even one participant of the conference can use the communication system 5.

The network 2 may include one or more of, for example, the Internet, a mobile communication network, a local area network (LAN). Alternatively, the communication network 2 may include a network by wireless communications such as 3rd generation (3G), 4th generation (4G), 5th generation (5G), wireless fidelity (Wi-Fi®), worldwide interoperability for microwave access (WiMAX) or long term evolution (LTE).

The terminal device 1 is an information processing device operated by the participant. The terminal device 1 transmits voice data spoken by the participant to the information processing apparatus 3. The terminal device 1 receives language information acquired by converting voice data into characters by a server, and displays the language information in the conversation accumulation area 101. The terminal device 1 repeats this process. The terminal devices 1 operated by the multiple participants participating in the conference are connected to the network 2. Each of the terminal devices 1 performs the same process and thus, the language information input by each of the participants is displayed in the conversation accumulation area 101 in time series.

The terminal device 1 may be, for example, a desktop PC, a notebook PC, a smartphone, or a tablet terminal that operates on a general operating system (OS) such as Windows®, MAC OS®, Android®, or iOS®. The terminal device 1 is a device on which an application such as a web browser can operate.

The terminal device 1 may be an output device such as an electronic whiteboard or a digital signage, a head up display (HUD) device, an industrial machine, a medical device, a network home appliance, a connected car, a mobile phone, a smartphone, a tablet terminal, a game machine, or a personal digital assistant (PDA).

The information processing apparatus 3 is an information processing apparatus that performs a function of providing information and a processing result in response to a request from the terminal device 1. Such an information processing apparatus is referred to as a server. In the communication system 5 according to the present embodiment, the information processing apparatus 3 may provide an image such as an illustration corresponding to the language information to the terminal device 1, in addition to performing the voice recognition described above. The voice recognition can also be performed in the terminal device 1. The information processing apparatus 3 transmits the language information to the generative AI system 4 and receives the analysis information (e.g., the agenda or topic described above).

The information processing apparatus 3 preferably has a function of a web server. The web server transmits various information such as a hypertext markup language (HTML) document stored in the web server, in accordance with the hypertext transfer protocol (HTTP) connected from the terminal device 1, based on the URL instructed by the web browser as the client. The information processing apparatus 3 can also transmit a web application to the terminal device 1. When the web browser executes the web application, the web browser and the web server communicate with each other. The web application is a program written in a programming language (e.g., JavaScript®) that operates on the web browser. The web application and the program on the web server cooperate with each other, and thus the web browser can provide various services to the participants. On the other hand, an application that is not executed unless the application is installed in the terminal device 1 is referred to as a native application.

The information processing apparatus 3 may support cloud computing. The “cloud computing” refers to internet-based computing where resources on a network are used or accessed without identifying specific hardware resources. The cloud computing may be in any type of software as a service (SaaS), platform as a service (PaaS), and infrastructure as a service (IaaS). The servers corresponding to the function of the web server, the function of voice recognition, and the function of searching for an illustration of the information processing apparatus 3 may be separately provided.

The generative AI system 4 provides a service in which the participants of a conference converse with an AI in a conversational manner. As such a generative AI system 4, a system using LLMs has been proposed. The LLMs are models for natural language processing that have been trained using a large amount of text data. The generative AI system 4 captures a huge amount of text in advance and learns knowledge from the text using deep learning or reinforcement learning. The generative AI system 4 can use this knowledge to perform various natural language processing. For example, natural language processing includes conversation, sentence summarization, creation of novels, translation, creation of minutes and reports, checking and proofreading of sentences, and program generation.

The participants of the conference can directly use the generative AI system 4. Alternatively, participants of the conference can use the generative AI system 4 via the information processing apparatus 3. For example, the participant operates the terminal device 1 to input a chat message and causes the terminal device 1 to transmit the chat message to the generative AI system 4. The generative AI system 4 generates an appropriate response message to the chat message and transmits the response message to the terminal device 1. Alternatively, the participant operates the terminal device 1 to input a chat message and causes the terminal device 1 to transmit the chat message to the information processing apparatus 3. The information processing apparatus 3 calls an application programming interface (API) published by the generative AI system 4 and transmits the chat message to the generative AI system 4. The generative AI system 4 generates an appropriate response message to the chat message and transmits the response message to the information processing apparatus 3. The information processing apparatus 3 transmits the response message to the terminal device 1. In the present embodiment, the generative AI system 4 may be used in either configuration.

In FIG. 2, the generative AI system 4 is illustrated separately from the information processing apparatus 3, but the information processing apparatus 3 and the generative AI system 4 may be integrated. In the present embodiment, a description is given below of a configuration in which the information processing apparatus 3 communicates with the generative AI system 4.

An interface with which the participant inputs a chat message to the generative AI system 4 is called a prompt. A chat message such as an instruction or a question is input to the prompt. The chat message may be a conversational sentence or a word composed of a natural language spoken by a human, and the chat message is referred to as language information in the present embodiment. The generative AI system 4 can also use an image as a chat message. The generative AI system 4 that generates a sentence for a chat message may be referred to as a generative AI. In the present embodiment, the generative AI system 4 generates an agenda or a topic for language information input by a participant.

As the generative AI system 4, a system using LLM such as GPT-3®, GPT-4®, Transformer®, BERT® has been proposed. The generative AI system 4 according to the present embodiment can use ChatGPT® using GPT-3 or GPT-4. Alternatively, the generative AI system 4 according to the present embodiment may use a system using another LLM.

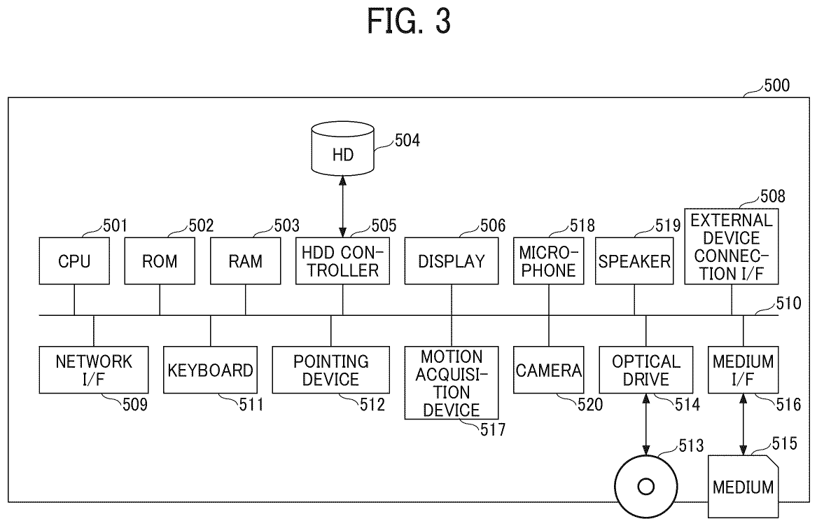

A description is given below of a hardware configuration of the information processing apparatus 3 and the terminal device 1 with reference to FIG. 3. FIG. 3 is a diagram illustrating the hardware configuration of the terminal device 1 and an information processing apparatus 3. Each of the terminal device 1 and the information processing apparatus 3 include a hardware configuration of a computer 500 as illustrated in FIG. 3.

As illustrated in FIG. 3, the computer 500 includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, an optical drive 514, and a medium I/F 516, a motion acquisition device 517, a microphone 518, a speaker 519, and a camera 520.

The CPU 501 controls the overall operation of the computer 500. The ROM 502 stores programs such as an initial program loader (IPL) to boot the CPU 501. The RAM 503 is used as a work area for the CPU 501. The HD 504 stores various data such as a program 500a. The HDD controller 505 controls the reading and writing of various data from and to the HD 504 under the control of the CPU 501. The display 506 displays various information such as a cursor, a menu, a window, a character, or an image. The external device connection I/F 508 is an interface for connecting the computer 500 to various external devices. In this case, the external devices include, but not limited to, a universal serial bus (USB) memory and a printer. The network I/F 509 is an interface for performing data communication using the network 2. The bus line 510 is, for example, an address bus or a data bus, which electrically connects the components illustrated in FIG. 3, such as the CPU 501.

The keyboard 511 is an input device provided with multiple keys for allowing the user to input characters, numerals, or various instructions. The pointing device 512 is an input device that allows the user to select or execute various instructions, select an item to be processed, or move the cursor being displayed. The optical drive 514 controls the reading or writing of various data with respect to an optical storage medium 513, which is a removable storage medium. The optical drive 514 is, for example, a compact disc (CD) drive, a digital versatile disk (DVD) drive, or a Blu-Ray™ drive. The medium I/F 516 controls the reading or writing (storing) of data from or to a recording medium 515 such as a flash memory.

The motion acquisition device 517 is a circuit that detects the motion of the participant and converts the motion into an electric signal and is a type of input method. The detection of the motion of the participant may be performed by any one of an optical method of detecting reflection of light, a magnetic sensor attached to the participant, a mechanical sensor, a method of using a detection result of the magnetic sensor, and a method of analyzing an image of the participant, or a combination thereof.

The microphone 518 is a built-in circuit that converts sound into an electrical signal. The speaker 519 is a built-in circuit that generates sound such as music or voice by converting an electrical signal into physical vibration. The microphone 518 and the speaker 519 may be built in or externally attached.

The camera 520 is a type of built-in imaging unit that images an object to acquire image data.

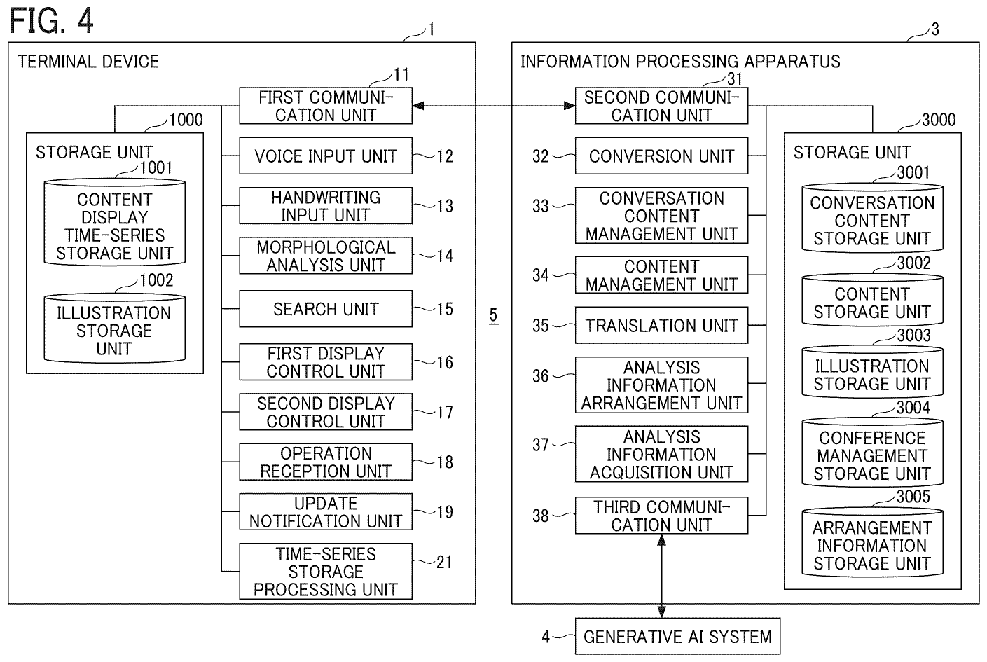

In the computer 500 applied to the information processing apparatus 3, the HDD controller 505 corresponds to the HD 504 and stores the program 500a. In the computer 500 applied to the terminal device 1, the program 500a is downloaded from the information processing apparatus 3 via the network 2 and stored in the HD 504, and the program 500a is read from the HD 504 and executed by the CPU 501. Then, the functional configuration as illustrated in FIG. 4 described later can be deployed in the RAM 503 collectively at the time of compilation or sequentially in accordance with the progress of processing. In the computer 500 applied to the information processing apparatus 3, the CPU 501 executes the program 500a, and thus the functional configuration as illustrated in FIG. 4 may be deployed in the RAM 503 collectively at the time of compilation or in accordance with the progress of the processing.

The computer 500 applied to the information processing apparatus 3 may omit the configuration related to the user interface. Alternatively, the computer 500 applied to the information processing apparatus 3 may omit at least one of the display 506, the keyboard 511, the pointing device 512, and the motion acquisition device 517.

A description is given below of a functional configuration of the present embodiment with reference to FIGS. 4 to 11. FIG. 4 is a functional block diagram of the communication system 5 in which functions are separately illustrated as blocks in an information processing apparatus 3 and a terminal device 1.

As illustrated in FIG. 4, the information processing apparatus 3 includes a second communication unit 31, a conversion unit 32, a conversation content management unit 33, a content management unit 34, a translation unit 35, an analysis information arrangement unit 36, an analysis information acquisition unit 37, and a third communication unit 38. These units included in the information processing apparatus 3 are functions or units functioning that are implemented by or caused to function by operating one or more hardware components illustrated in FIG. 3 in cooperation with instructions of the CPU 501 according to the program loaded from the HD 504 to the RAM 503. The information processing apparatus 3 further includes a storage unit 3000 implemented by the RAM 503 and the HD 504 illustrated in FIG. 3.

The second communication unit 31 communicates with one or more terminal devices 1 via the network 2. The second communication unit 31 receives voice data or handwritten data from the terminal device 1 and transmits language information converted from the voice data or handwritten data to the terminal device 1. The second communication unit 31 may receive language information input by the participant using the keyboard from the terminal device 1.

The conversion unit 32 performs character recognition processing on voice data spoken by the participant or one or more stroke data (handwritten data) handwritten by the participant, and converts the voice data or the stroke data into language information. The language information actually consists of a character code. The conversion unit 32 recognizes characters (not only Japanese but also multilingual languages such as English), numerals, symbols (%, $, &, etc.), and graphics (lines, circles, triangles, etc.) in parallel with the speech of the participant and the writing operation by pen of the participant. Various algorithms for the recognition method have been proposed, but in the present embodiment, a known technique can be used, and therefore, the details thereof are omitted. The conversion unit 32 use algorithms that are suitable for voice data and the handwritten data respectively. The conversion unit 32 performs character recognition processing on voice data which is voice information based on a voice spoken by a participant or one or more stroke data (handwritten data) handwritten by the participant, and converts the voice data or the stroke data into language information. In the present embodiment, the speech of the participant is referred to as “voice” and the voice converted into data is referred to as “voice data” for distinction, but in the present embodiment, they are not strictly distinguished for ease of description.

The conversion by the conversion unit 32 may be performed by the terminal device 1. The conversion unit 32 may be included in a server independent of the information processing apparatus 3. In this case, the terminal device 1 or the information processing apparatus 3 transmits voice data or handwritten data to the server to acquire language information.

The conversation content management unit 33 stores the language information converted from the voice data of each terminal device 1 by the conversion unit 32 in a conversation content storage unit 3001. The conversation history is stored in the conversation content storage unit 3001 in time series.

The content management unit 34 manages language information and illustrations displayed in the whiteboard work area 102. The content is managed in a content storage unit 3002 described later. Since the whiteboard work area 102 is shared on the terminal devices 1, the content storage unit 3002 includes the content arranged by each participant. When the whiteboard work area 102 is different for each terminal device 1, the content storage unit 3002 manages the content arranged by the participant for each participant.

When the language used by the terminal device 1a is different from the language used by the other terminal devices 1b and 1c, the translation unit 35 translates the language information from the language used by the terminal device 1a to the language used by the other terminal devices 1b and 1c. Conversely, the translation unit 35 translates the language information from the language used by the other terminal devices 1b and 1c into the language used by the terminal device 1a.

The third communication unit 38 calls the API published by the generative AI system 4 to transmit a request message to the generative AI system 4 and receives a response message as a response to the request message. The request message includes language information, speaker information, and date and time. The response message includes analysis information (agenda, topic, summary, divergence information, convergence information, and keyword) generated by the generative AI system 4.

When the language information in a predetermined range is accumulated in the information processing apparatus 3, the analysis information acquisition unit 37 transmits the analysis of the language information according to the analysis content set by the participant to the generative AI system 4 via the third communication unit 38. The analysis information acquisition unit 37 receives analysis information generated as an analysis result by the generative AI system 4 analyzing the language information via the third communication unit 38. The analysis information acquisition unit 37 acquires analysis information of a type corresponding to the analysis content set by the participant.

The analysis information arrangement unit 36 uses an arrangement information table of an arrangement information storage unit 3005 described later to determine the arrangement of the analysis information acquired from the generative AI system in the whiteboard work area 102. The analysis information arrangement unit 36 determines arrangement of the analysis information according to the type of analysis information generated by the generative AI system 4, for example.

The terminal device 1 may include some or all of the functions of the information processing apparatus 3 except for the second communication unit 31.

A description is given below of the conversation content storage unit 3001, the content storage unit 3002, an illustration storage unit 3003, a conference management storage unit 3004, and the arrangement information storage unit 3005 stored in the storage unit 3000.

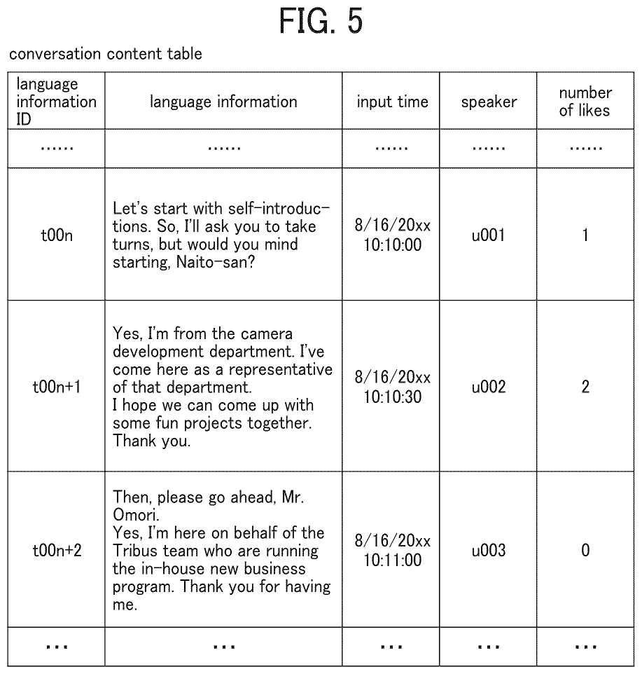

FIG. 5 is a conceptual diagram illustrating a conversation content table. In the storage unit 3000, the conversation content storage unit 3001 storing the conversation content table as illustrated in FIG. 5 is stored. In the conversation content table, the items of language information ID, language information, input time, speaker, and the number of likes are stored in association with each other. The item of language information ID is identification information of language information displayed in the conversation accumulation area 101. The conversation content management unit 33 numbers language information IDs so that the language information IDs are not to overlap based on the fixed number of characters or a silent time. The item of language information is language information displayed in the conversation accumulation area 101 and is converted from voice data by the conversion unit 32. The item of input time is a time at which the language information is input, and is, for example, a time at which the conversion unit 32 finishes the conversion from the voice data into the language information. The item of speaker is identification information of a participant who has spoken language information as a voice. The identification information may be referred to as a participant ID in the following description. The identification information of the participant is transmitted to the information processing apparatus 3 together with the voice data. The identification information of the participant is identified when the participant logs in to the information processing apparatus 3. When multiple participants participate in the conference room but do not log in, the terminal device 1 may recognize the speaker by a camera or a voiceprint. The item of the number of likes is the number of times the like button is pressed for the language information. The like button indicates a favorable reaction, and the number of “likes” is the number of favorable reactions.

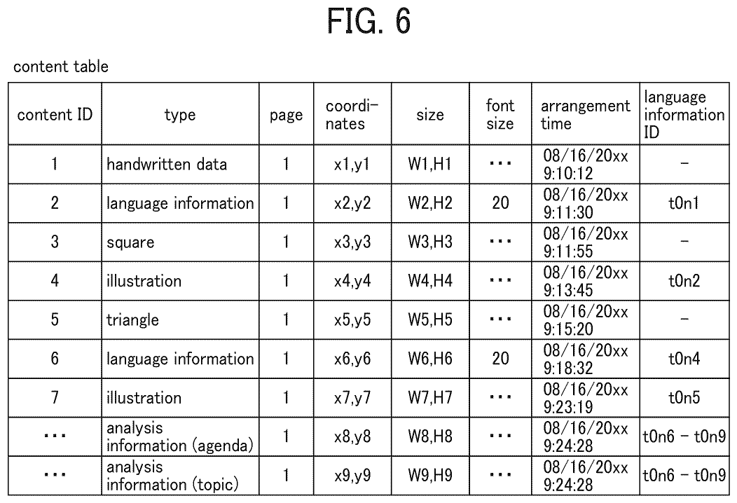

FIG. 6 is a conceptual diagram illustrating a content table. In the storage unit 3000, the content storage unit 3002 storing the content table as illustrated in FIG. 6 is stored. The content is visual information arranged in the whiteboard work area 102. In the content table, the items of a content ID, a type, a page, coordinates, a size, a font size, an arrangement time, and a language information ID are stored in association with each other.

The item of content ID is identification information for identifying content. The content ID is numbered by the content management unit 34.

The item of the type is the type of the content, and the type of the content includes handwriting, language information, a graphic (a square or a triangle), an illustration, a table, and analysis information. The handwriting is stroke data (a sequence of coordinate points). The language information is one or more characters or symbols (character codes) arranged in the whiteboard work area 102. The graphic is a geometric shape such as a triangle or a square converted from handwritten data or language information. The illustration is image data such as jpeg, png, or tiff that is searched by language information or directly arranged. The table is a one dimensional or two dimensional table-like content. The analysis information indicates that the content is generated by the generative AI system 4 and the type of the analysis information.

One screen of the whiteboard work area 102 is referred to as a page. The item of the page indicates the page number.

The item of coordinates indicates the position of the content with respect to a predetermined origin of the whiteboard work area 102. The position of the content is, for example, the upper left vertex of the circumscribed rectangle of the content. The coordinates are expressed, for example, in pixels of the display.

The item of size indicates the width and height of the circumscribed rectangle of the content.

The item of font size is the size of one character set for the content of which the type is language information. In addition, color and font may be set for the language information.

The item of the arrangement time is the date and time when the content is first arranged in the whiteboard work area 102. The arrangement may be transferred from the conversation accumulation area 101. Alternatively, the arrangement may be directly handwritten on the whiteboard work area 102 by the participant. The “first” indicates that the arrangement time is not changed even when the language information is broken down by the morphological analysis or the size of the illustration is changed. This is to maintain the relation with the input time of the language information in the conversation accumulation area 101.

The item of the language information ID is a language information ID of the language information in a case where the language information or the illustration is derived from the language information in the conversation accumulation area 101 (in a case where the illustration is copied or searched from the conversation accumulation area 101). The language information ID of the content table associates each content with the language information of the conversation accumulation area 101. In other words, the language information ID is not set when the content is not derived from the language information of the conversation accumulation area 101. When the type is analysis information, the language information ID indicates which language information the content was generated from.

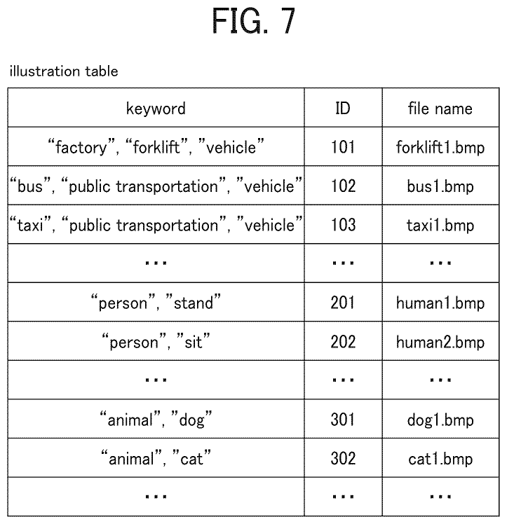

FIG. 7 is a conceptual diagram illustrating an illustration table. In the storage unit 3000, the illustration storage unit 3003 storing the illustration table as illustrated in FIG. 7 is stored. The illustration table is a table for converting a keyword included in the language information into an illustration. In the illustration table, the items of a keyword, an ID, and a file name are stored in association with each other. The item of keyword is the name or the name of the illustration and includes character strings to be searched. An illustration of a file name associated with a keyword at least partially matching a word included in the language information is displayed on the terminal device 1. The keyword may be any of a word, a phonetic character, an ideographic character, a sentence, a number, and a combination thereof. The item of ID is identification information of the illustration. The item of file name is a file name in which the illustration is stored.

The illustration table as illustrated in FIG. 7 is registered in the information processing apparatus 3 in advance by an administrator. Alternatively, a search unit 15 of the terminal device 1 may search for an illustration on the Internet without preparing the illustration table. Alternatively, the generative AI system 4 may generate an illustration corresponding to a word included in the language information.

The illustration may include a three dimensions (3D) model or a three dimensional illustration. The 3D model or the three dimensional illustration is a virtual three dimensional object in a three dimensional space. The participant can view the 3D model or the three dimensional illustration from any direction within 360-degree, and the information processing apparatus 3 can convert the illustration into a two dimensional plane illustration.

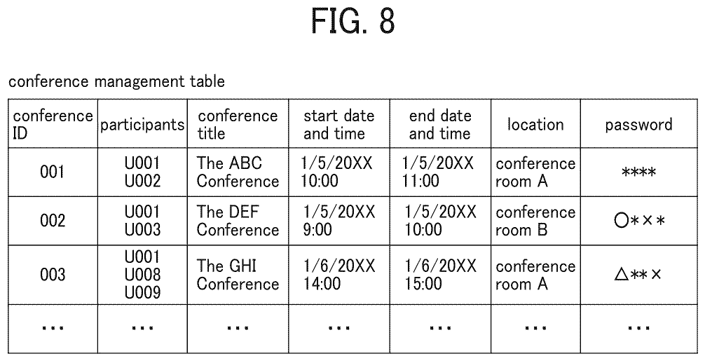

FIG. 8 is a conceptual diagram illustrating a conference management table. In the storage unit 3000, a conference management storage unit 3004 storing the conference management table as illustrated in FIG. 8 is stored. The conference management table is information on a conference conducted by a participant using the information display screen 100, but information on a conference not using the information display screen 100 may also be registered. In the conference management table, the items of participants, a conference title (conference name), a start date and time, an end date and time, a location, and a password are stored in association with a conference ID. The item of participants indicates one or more persons who participate in a conference. The item of conference title indicates content of the conference such as a name of the conference or an agenda of the conference. The item of start date and time indicates a date and time at which the conference is scheduled to be started. The item of end date and time indicates a date and time at which the conference is scheduled to be ended. The item of location indicates a place where the conference is conducted such as a name of a conference room, a name of a branch office, or a name of a building. The item password is authentication information for participating in the conference and is distributed to the participants in advance.

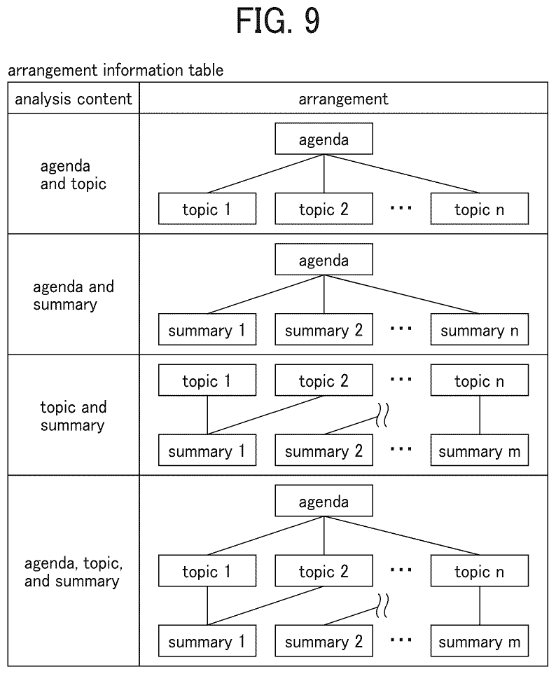

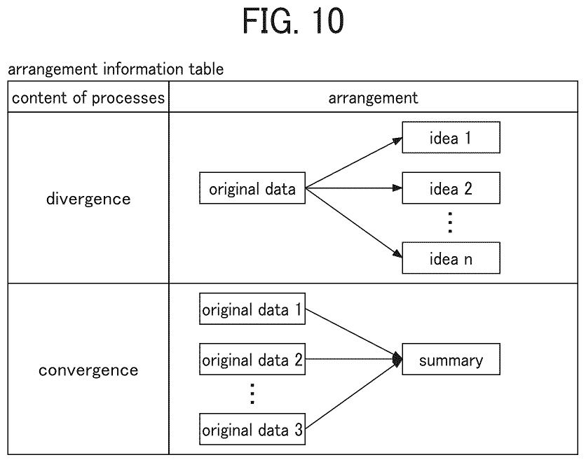

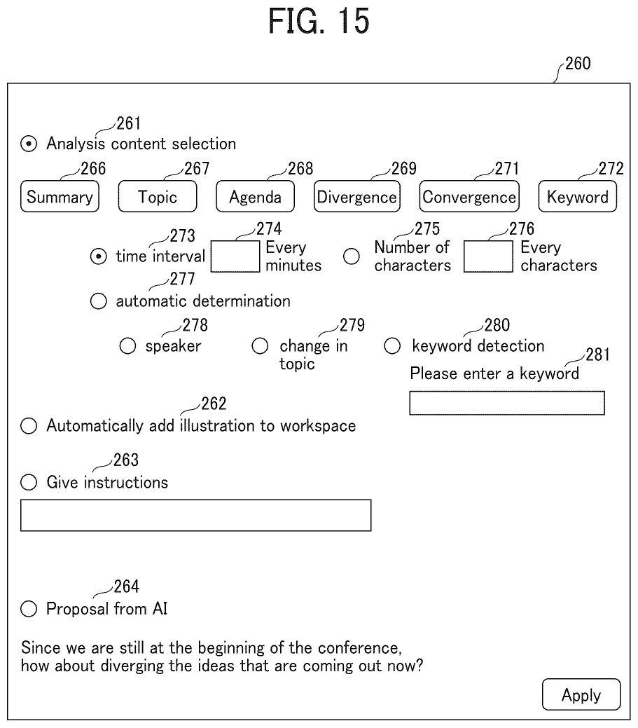

FIGS. 9 and 10 are conceptual diagrams illustrating arrangement information tables. In the storage unit 3000, an arrangement information storage unit 3005 storing an arrangement information table as illustrated in FIG. 9 is stored. The arrangement information table is information for determining how the terminal device 1 arranges the analysis information generated by the generative AI system 4 in the whiteboard work area 102. The arrangement information table associates the analysis content with the arrangement of the type of analysis information. As described with reference to FIG. 15 later, in the present embodiment, the type of analysis information determined by the analysis content is generated.

For example, in the arrangement information storage unit 3005, when the analysis content is “agenda and topic,” an arrangement in which the agenda is set as a parent hierarchy and the topic is set as a child hierarchy and the topics are arranged in parallel is registered in advance. Similarly, the arrangement of the analysis information is determined in association with “agenda and summary”, “topic and summary”, and “agenda, topic, and summary”, which are combinations of the analysis content.

For the “topic and the summary” whose correspondence is not clear as illustrated in FIG. 9, the generative AI system 4 preferably transmits the correspondence (which topic corresponds to which summary) to the information processing apparatus 3 together with the analysis information. The analysis information arrangement unit 36 connects the topic and the summary with lines based on the correspondence relation.

In FIG. 9, the arrangement in the case where the analysis content is only one of “agenda”, “summary”, and “topic” is not registered. However, in the case where the analysis content is only one, the type of the analysis information is also only one, and thus the analysis information is arranged, for example, in series or in parallel.

As illustrated in FIG. 10, in the case of a “divergence”, an arrangement in which “idea 1” to “idea n” are connected by arrows from an “original data” is registered in advance. The original data is an idea that is extracted from the language information by the generative AI system 4. The idea 1 to idea n are ideas acquired by the generative AI system 4 developing the original data. In the case of a “convergence”, an arrangement in which “original data 1” to “original data n” are grouped by arrows is registered in advance. The original data 1 to original data n are some ideas extracted from the language information by the generative AI system 4. The summary is information in which the generative AI system 4 summarizes the original data 1 to original data n. As illustrated in FIG. 10, since one piece of analysis information and the other piece of analysis information are connected, the generated information is displayed as a flowchart or a mind map.

The analysis information arrangement unit 36 refers to the arrangement information table based on the type of the analysis information received from the generative AI system 4 to determine the arrangement of the analysis information. The analysis information arrangement unit 36 determines the arrangement of the analysis information so as not to overlap the content that has been already displayed in the whiteboard work area 102. For example, the analysis information arrangement unit 36 specifies the position of the circumscribed rectangle of the content that has been displayed from the content table, determines whether the circumscribed rectangle of the analysis information to be arranged overlaps, and performs adjustment such as moving the analysis information or setting the child hierarchy or the grandchild hierarchy to two stages in a case where the circumscribed rectangle overlaps.

Returning to FIG. 4, a description is given below of the terminal device 1. The terminal device 1 includes a first communication unit 11, a voice input unit 12, a handwriting input unit 13, a morphological analysis unit 14, a search unit 15, a first display control unit 16, a second display control unit 17, an operation reception unit 18, an update notification unit 19, and a time-series storage processing unit 21. These units included in the terminal device 1 are functions or units functioning that are implemented by or caused to function by operating one or more hardware components illustrated in FIG. 3 in cooperation with instructions of the CPU 501 according to the program loaded from the HD 504 to the RAM 503. The terminal device 1 further includes a storage unit 1000 implemented by the RAM 503 and the HD 504 illustrated in FIG. 3.

The first communication unit 11 communicates with the information processing apparatus 3 via a network. The first communication unit 11 transmits voice data or handwritten data to the information processing apparatus 3, and receives language information converted from the voice data or the handwritten data. The first communication unit 11 may transmit the language information input through the keyboard to the information processing apparatus 3.

The voice input unit 12 receives an input of voice collected by the microphone 518 and acquires voice data as voice information based on the received voice. In other words, the voice input unit 12 performs pulse code modulation (PCM) on voice that is an analog signal, and converts the voice into voice data that is digital data.

The handwriting input unit 13 detects coordinates of a position where an input method such as a pen is in contact with the touch screen to receive input of stroke data (a sequence of coordinate points). The handwriting input unit 13 may receive input of stroke data (a sequence of coordinate points) in response to a mouse operation. The handwriting input unit 13 interpolates and connects the sequence of coordinate points to generate stroke data. The stroke data is information displayed on the display based on a locus of coordinates input by the input method. The stroke data may be interpolated appropriately. The handwritten data is data including one or more stroke data.

The morphological analysis unit 14 performs morphological analysis on any language information transmitted from the information processing apparatus 3, and breaks down the information into words with parts of speech. The morphological analysis is to break down the language information into minimum units including meaning and to determine the meaning and the parts of speech.

The search unit 15 searches for a character string such as a word broken down by the morphological analysis unit 14 on an illustration storage unit 1002 or the Internet. The search unit 15 acquires an illustration matching the character string from the illustration storage unit 1002.

The first display control unit 16 displays language information, an illustration list, and a menu icon in the conversation accumulation area 101 of the information display screen 100. The second display control unit 17 displays language information, analysis information, an illustration list, an illustration, and a menu icon in the whiteboard work area 102 of the information display screen 100.

The operation reception unit 18 receives various operations in the conversation accumulation area 101 or the whiteboard work area 102. The operations in the conversation accumulation area 101 or the whiteboard work area 102 include pressing of the menu icon, selection of the language information, selection of the illustration, selection of content, editing of the content, movement of the content, and deletion of the content.

When the content of the whiteboard work area 102 is changed, the update notification unit 19 notifies the information processing apparatus 3 of information about the content to share the content with the other terminal devices 1b and 1c. The change in content may include changes to be shared for the content, such as location, size, and color.

The time-series storage processing unit 21 stores the state of the conversation accumulation area 101 and the state of the whiteboard work area 102 in a content display time-series storage unit 1001 in association with each other. Thus, the content can be reproduced in time series while being synchronized with the language information.

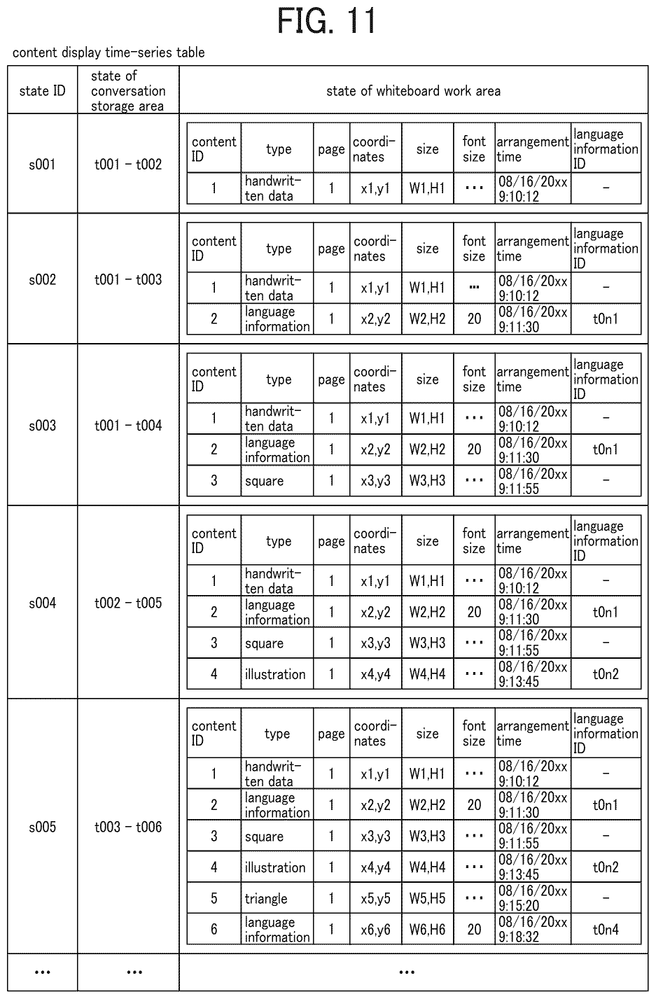

FIG. 11 is a conceptual diagram illustrating a content display time-series table. In the storage unit 1000, a content display time-series storage unit 1001 storing the content display time-series table as illustrated in FIG. 11 is stored. In the content display time-series table, the state of the conversation accumulation area 101 and the state of the whiteboard work area 102 are stored in association with the state ID in time series.

The item of the state ID is identification information of the state of the conversation accumulation area 101 and the state of the whiteboard work area 102.

The state of the conversation accumulation area 101 indicates which language information is displayed in the conversation accumulation area 101 by the language information ID. For example, when the state ID is s001, language information of t001 to t002 is displayed in the conversation accumulation area 101, and the content indicated by the state of the whiteboard work area 102 with the state ID of s001 is displayed in the whiteboard work area 102 in the state where language information of t001 to t002 is displayed. Subsequently, t003 is added to the conversation accumulation area 101, and the content indicated by the state of the whiteboard work area 102 with the state ID of s002 is displayed in the whiteboard work area 102 in the state where language information of t001 to t003 is displayed. As described above, the state of the conversation accumulation area 101 and the state of the whiteboard work area 102 are associated with each other.

The state of the whiteboard work area 102 is indicated by the content display time-series table described above. Thus, the terminal device 1 can reproduce the past state of the whiteboard work area 102 as it is, instead of an image such as a snapshot. However, the state of the whiteboard work area 102 may be stored as an image such as a snapshot. The overall information display screen 100 may be recorded as a moving image.

The content display time-series storage unit 1001 may be recorded by the information processing apparatus 3 and transmitted to the terminal device 1. However, the number of pieces of language information that can be displayed in the conversation accumulation area 101 may vary depending on the terminal device 1, and in such a case, it is preferable to store the content display time-series storage unit 1001 for each terminal device 1.

The illustration storage unit 1002 included in the terminal device 1 may have the same configuration as the illustration storage unit 3003 included in the information processing apparatus 3. When the terminal device 1 executes a web application, the terminal device 1 connects to the information processing apparatus 3 to download the illustration storage unit 1002 from the information processing apparatus 3 to the terminal device 1. When the terminal device 1 executes a native application, the illustration storage unit 1002 is included in the native application in advance. When the terminal device 1 executes the native application, the illustration storage unit 1002 may be downloaded.

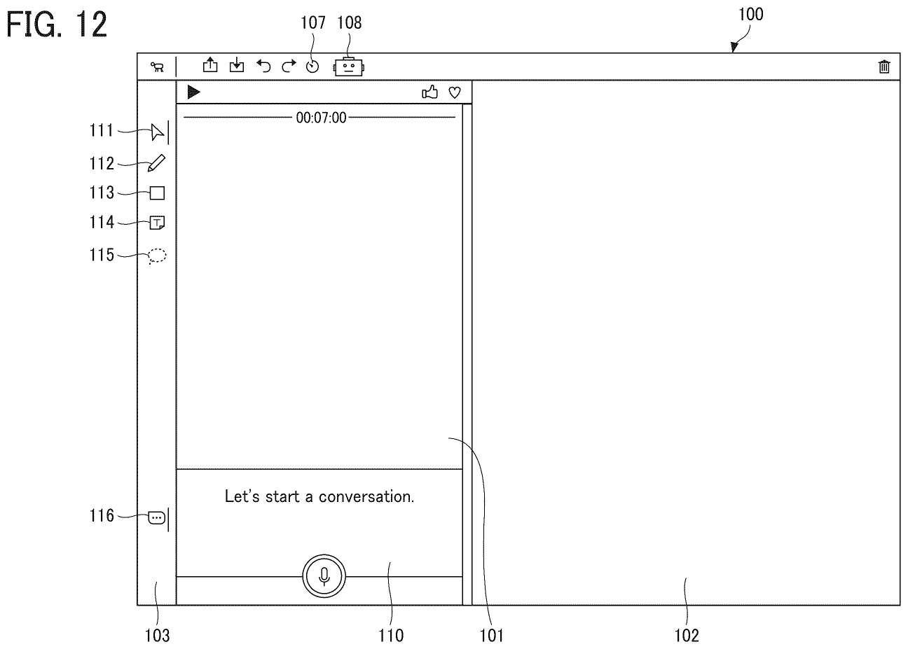

A description is given below the information display screen 100 displayed by the terminal device 1 with reference to FIG. 12. FIG. 12 is a diagram illustrating the information display screen 100 in an initial state displayed by the terminal device 1. The information display screen 100 may be a web application or a native application.

The information display screen 100 includes a conversation accumulation area 101, a whiteboard work area 102, a tool display field 103, and a voice recognition result display field 110.

The tool display field 103 displays various tools. The tools displayed in the tool display field 103 include a content selection tool 111, a pen tool 112 for handwriting input, a graphic tool 113 for drawing a graphic, a text tool 114 for inputting characters, and a lasso tool 115. A transfer button 107 and a generative AI setting button 108 are displayed in the upper portion of the information display screen 100. The tools described above are examples. The tools include a toggle visibility switching tool 116 for the conversation accumulation area 101. When the toggle visibility switching tool 116 is pressed, the conversation accumulation area 101 is closed, and the whiteboard work area 102 is enlarged accordingly. When the transfer button 107 is pressed, a reproduce mode is started, and the language information and the content are reproduced based on the content display time-series storage unit 1001. In other words, the content is displayed in time series while being synchronized with the language information. The generative AI setting button 108 is described later.

In the conversation accumulation area 101, the language information converted from the voice data is displayed in time series. When new language information is added to the conversation accumulation area 101, the old language information moves from the top to the bottom. The language information that has reached the bottom of the conversation accumulation area 101 is scrolled out. Even if the language information is scrolled out, the participant can operate the scroll bar to display the past language information.

The voice recognition result display field 110 displays in real time the language information converted from the voice data acquired by the voice input unit 12 of the terminal device 1a. The language information being displayed in the voice recognition result display field 110 may also be shared with the other terminal devices 1b and 1c. An illustration is automatically displayed for the language information being displayed in the voice recognition result display field 110. For example, when a silent state continues for a certain time or more, the language information being displayed in the voice recognition result display field 110 is transmitted to the information processing apparatus 3. The information processing apparatus 3 transmits information indicating that the language information for which the conversion is completed is displayed in the conversation accumulation area 101 to each terminal device 1, and thus the language information is displayed in the conversation accumulation area 101 of each terminal device 1 and is shared between the terminal devices 1.

The participant can input any content in the whiteboard work area 102. In other words, the participant can use the whiteboard work area 102 like an electronic whiteboard. As described later, the analysis information is automatically displayed in the whiteboard work area 102. The participant can manually copy the language information in the conversation accumulation area 101 to the whiteboard work area 102.

The participant may be able to adjust the positions and sizes of the conversation accumulation area 101 and the whiteboard work area 102. For example, the participant switches the left and right sides of the conversation accumulation area 101 and the whiteboard work area 102. When the participant enlarges the whiteboard work area 102, the conversation accumulation area 101 may be shrunk accordingly. The same applies to a case where the participant changes the size of the conversation accumulation area 101. The whiteboard work area 102 may be larger than the display 506. In this case, the display 506 displays a part of the whiteboard work area 102 on the display 506 in response to an operation of the participant.

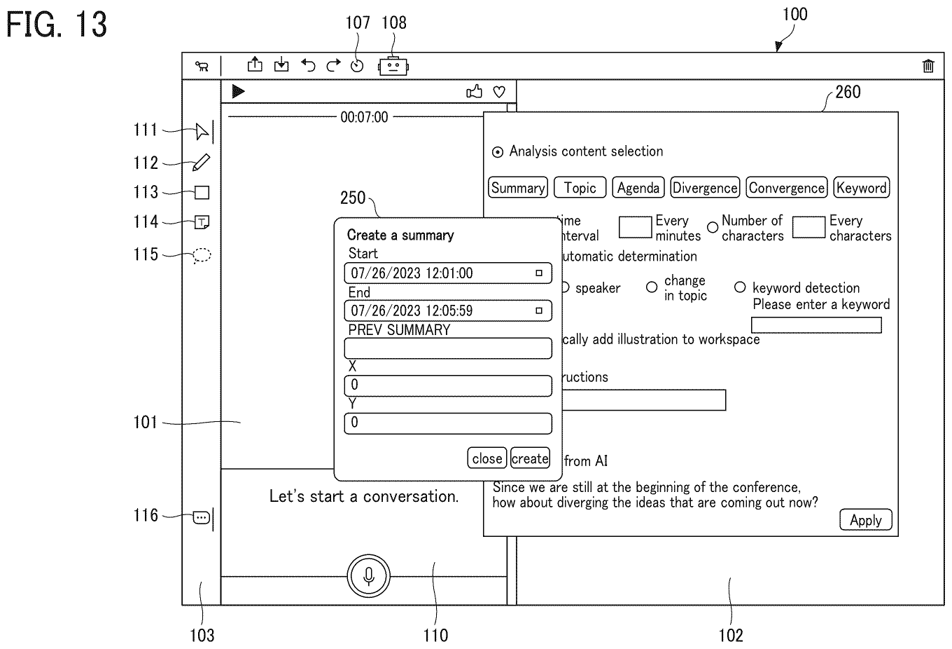

FIG. 13 is a diagram illustrating a first setting screen 250 and a second setting screen 260 displayed when the generative AI setting button 108 is pressed. As illustrated in FIG. 13, the first setting screen 250 and the second setting screen 260 are popped up and are displayed overlapping each other. However, the first setting screen 250 and the second setting screen 260 may be displayed in any manner. For example, the first setting screen 250 and the second setting screen 260 may be displayed on different pages. The screen information (web application) of the first setting screen 250 and the second setting screen 260 is transmitted to the terminal device 1 by the information processing apparatus 3 and is displayed by the terminal device 1. When a native application is operated in the terminal device 1, the native application includes the configurations of the first setting screen 250 and the second setting screen 260 in advance.

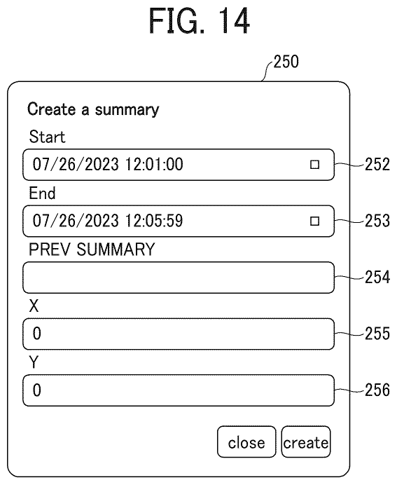

FIG. 14 is an enlarged view of the first setting screen 250. In the first setting screen 250, the participant designates any range of the conversation accumulation area 101 or designates where the analysis information is arranged in the whiteboard work area 102. The first setting screen 250 includes a start field 252, an end field 253, a preview summary field 254, an X field 255, and a Y field 256. The start field 252 is a field for designating a date and time when the generative AI system 4 starts analysis of the language information. The end field 253 is a field for designating a date and time when the generative AI system 4 ends the analysis of the language information. The generative AI system 4 analyzes the language information in the range from the start field 252 to the end field 253 to generate analysis information. As illustrated in FIG. 5, the language information is associated with the input time. For example, the participant can designate a range of past time to display the analysis information. The participant may designate a range of future times, such as the scheduled time of the conference. The start field 252 and the end field 253 are examples of a method for designating the range of the language information.

The preview summary field 254 is a column in which a summary of language information is displayed when the language information is already present in the time range from the start field 252 to the end field 253. In the X field 255 and the Y field 256, the participant sets the display position (starting point) of the analysis information in the whiteboard work area 102.

The setting of the first setting screen 250 may not be set, and the second setting screen 260 alone described below may be set.

FIG. 15 is an enlarged view of the second setting screen 260. The second setting screen 260 is a screen for the participant to set the analysis content that the information processing apparatus 3 requests the generative AI system 4 to perform, and a screen for the participant to set the range of the language information to be analyzed. The method of setting the analysis content includes a method of selecting an instruction in the analysis content selection field 261 and a method of inputting a natural language in the instruction input field 263 to give an instruction. A description is given below of the method of setting the analysis content.

In the analysis content selection field 261, the participant can select the analysis content and the range of the language information of the conversation accumulation area 101 to be analyzed. There are five analysis content: a summary 266, a topic 267, an agenda 268, divergence 269, convergence 271, and a keyword 272. These five analysis content is the type of analysis information. The participant can select one or more of the five types at the same time. When the summary 266 is selected, the generative AI system 4 generates a summary of the language information in the designated range of the conversation accumulation area 101. The summary is information in which the main points of the language information are summarized briefly. When the topic 267 is selected, the generative AI system 4 generates a topic of the language information in the designated range of the conversation accumulation area 101. The topic is a topic or a subject of language information represented by a sentence shorter than the summary. When the agenda 268 is selected, the generative AI system 4 generates an agenda of the language information in the designated range of the conversation accumulation area 101. The agenda is a theme or a purpose discussed in the conference. When the divergence 269 is selected, the generative AI system 4 generates divergence information in which the contents of the language information in the designated range of the conversation accumulation area 101 are diverged. Divergence indicates that many ideas are given as candidates. When the convergence 271 is selected, the generative AI system 4 generates convergence information in which the contents of the language information in the designated range of the conversation accumulation area 101 are converged. The convergence indicates to select an idea with a high agreement, an idea with a long discussion time, or an emphasized idea from the language information in the conversation accumulation area 101. When the keyword 272 is selected, the generative AI system 4 extracts a keyword (e.g., a noun) from the language information in the designated range of the conversation accumulation area 101.

The analysis content in FIG. 15 may be selected from a search, a conclusion, a decision, an action item, and a next content. The search indicates to a buzz word, a keyword having a high search frequency on a network, an abbreviated word, and a keyword having a high speech frequency among the keywords 272. Narrowing down the search can reduce the whiteboard work area 102 from being complicated. The generative AI system 4 generates the conclusion, the decision, the action item, and the next content, and thus the participant can easily share the information.

A description is given below of the range of the language information of the conversation accumulation area 101 to be analyzed. The analysis content selection field 261 includes options of a time interval 273, the number of characters 275, and automatic determination 277 as the generation timing of the analysis information. The time interval 273 is, for example, a setting in which the generative AI system 4 analyzes the language information for N minutes set in a time setting field 274 by the participant. The number of characters 275 is, for example, a setting for the generative AI system 4 to analyze the language information of the number set in the number of characters setting field 276 by the participant.

The automatic determination 277 indicates that the generative AI system 4 automatically determines the range of the language information of the conversation accumulation area 101 to be analyzed. When the automatic determination 277 is selected, the participant can select a method of determining the generation timing. The options of the generation timing are, for example, a speaker 278, a change in topic 279, and a keyword detection 280. When the speaker 278 is selected, the generation timing is when the speaker of the conversation accumulation area 101 is switched. In other words, the designated range is the language information from the last speaker switching of the language information to the next speaker switching. When the change in topic 279 is selected, the generation timing is when the topic of the language information in the conversation accumulation area 101 is changed. In other words, the designated range is the language information from the last change of topic to the next change of topic. The generative AI system 4 determines the change of topic. When the keyword detection 280 is selected, the generation timing is when the keyword set in a keyword field 281 is detected from the language information in the conversation accumulation area 101.

The time interval 273, the number of characters 275, or the automatic determination 277 is an example of a method for designating the range of the language information. Even when the time interval 273, the number of characters 275, or the automatic determination 277 is selected, the participant can manually designate the range of the language information and cause the generative AI system 4 to generate the analysis information.

When the start field 252 and the end field 253 are set in the first setting screen 250, the time interval 273, the number of characters 275, or the automatic determination 277 may be valid only in the range of the time set in the start field 252 and the end field 253, or may be valid regardless of the range of the time set in the start field 252 and the end field 253.

A description is given below of the instruction input field 263. The participant can input the analysis content and the range of the language information of the conversation accumulation area 101 to be analyzed in natural language to the instruction input field 263. The participant can turn on or off the radio button in the instruction input field 263 to set whether to give the instruction in the instruction input field 263 to the generative AI system 4. The input to the instruction input field 263 may be voice or keyboard input. In the instruction input field 263, for example, the participant can express an instruction in a natural language to input the instruction that cannot be selected in the analysis content selection field 261. For example, the participant can input the instruction such as “extract only questions” and “list only decisions” in the instruction input field 263. The participant may input the same instruction as that in the analysis content selection field 261 in natural language. The participant can input, for example, “generate a summary every three minutes and automatically generate a topic when a topic changes” in the instruction input field 263.

A description is given below of an illustration setting field 262. In the illustration setting field 262, the participant can set whether to automatically display an illustration in the whiteboard work area 102. When the radio button of the illustration setting field 262 is selected, the illustration related to the analysis information arranged in the whiteboard work area 102 is automatically displayed. In the conversation accumulation area 101, an illustration list matching the keyword is automatically displayed regardless of the setting in the illustration setting field 262. However, the participant may be able to set whether to automatically display the illustration list in the conversation accumulation area 101.

The second setting screen 260 includes a proposal display field 264. In the proposal display field 264, the generative AI system 4 proposes to the participant what fields should be selected in the analysis content selection field 261 or what instruction is input in the instruction input field 263. For example, in FIG. 15, a proposal “Since we are still at the beginning of the conference, how about diverging the ideas that are coming out now?” is displayed. For example, at the end of the conference, the generative AI system 4 is expected to propose “Since the conference is at the end, how can the ideas so far converge?”. The participant can turn on or off a radio button in the proposal display field 264 to set whether to receive a proposal from the generative AI system 4.

The first setting screen 250 or the second setting screen 260 can be displayed on any terminal device 1. When any analysis content set in each terminal device 1 is valid in the information processing apparatus 3, analysis information that is generated from the same language information and corresponded to the analysis content (the analysis content may be the same or different) may be displayed in the whiteboard work area 102. For example, multiple agendas may be generated from the same range of language information (since the range of language information is the same, multiple same agendas are displayed). In order to reduce such complicated display of the analysis information, the following exclusive control may be performed. The information processing apparatus 3 generates analysis information only once from the same language information. Since the language information used to generate the analysis information is registered in the content table, the analysis information acquisition unit 37 does not transmit the language information registered in the content table to the generative AI system 4. In this case, the information processing apparatus 3 may transmit an error message to the terminal device 1 that has transmitted the analysis content. The information processing apparatus 3 restricts the terminal device 1 that can display the first setting screen 250 or the second setting screen 260 to, for example, the organizer of the conference. The information processing apparatus 3 transmits the authority to display the first setting screen 250 or the second setting screen 260 only to the terminal device 1 of the organizer. When the generative AI setting button 108 is pressed in the terminal device 1 without authority, an error message is displayed.

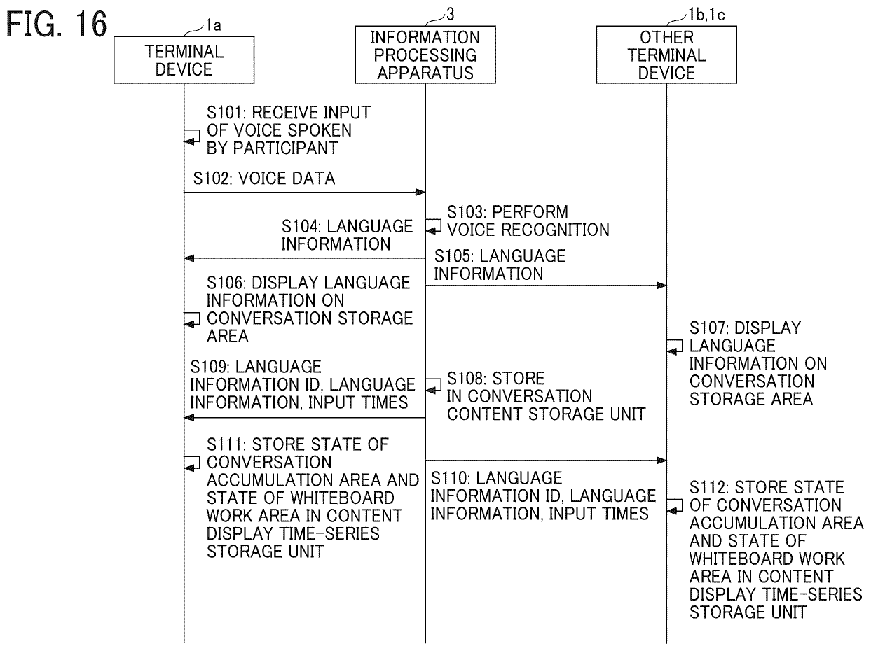

A description is given below of a processing flow in which the terminal devices 1 participating in the conference share the language information converted from the voice data with reference to FIG. 16. A case where the generative AI system 4 does not generate analysis information is described below. FIG. 16 is a sequence diagram illustrating a process in which the terminal device 1a transmits voice data to the information processing apparatus 3 and the information processing apparatus 3 shares language information converted from the voice data with the other terminal devices 1b and 1c. The terminal device 1a and the other terminal devices 1b and 1c participate in the same conference by connecting to the URL invited by e-mail, and the information processing apparatus 3 manages the multiple terminal devices 1 participating in the same conference by participant IDs and internet protocol (IP) addresses. Alternatively, each participant may select a conference registered in the conference management table using the terminal devices 1a to 1c and input a predetermined password to participate in the same conference. In this case, the information processing apparatus 3 also manages the multiple terminal devices 1 participating in the same conference by participant IDs and IP addresses.

In step S101, the voice input unit 12 of the terminal device 1a receives an input of a voice spoken by a participant.

In step S102, the voice input unit 12 transmits the voice data converted to digital data to the information processing apparatus 3 via the first communication unit 11.

In step S103, the second communication unit 31 of the information processing apparatus 3 receives the voice data, and the conversion unit 32 of the information processing apparatus 3 performs voice recognition on the voice data and converts the voice data into language information based on the voice data.

In steps S104 and S105, the second communication unit 31 transmits the language information to the terminal device 1a and the other terminal devices 1b and 1c participating in the conference. Since the voice recognition is performed in real time, the content of the speech may not be determined at this time.

In steps S106 and S107, the first communication unit 11 of each of the terminal device 1a and the other terminal devices 1b and 1c receives the language information, and the first display control unit 16 of each of the terminal device 1a and the other terminal devices 1b and 1c displays the undetermined language information in the voice recognition result display field 110 as appropriate.

In step S108, when the conversation content management unit 33 of the information processing apparatus 3 detects a break in speech based on a silent time, the conversation content management unit 33 stores language information IDs (newly numbered), language information, input times, speakers (participants who have logged in), and the number of likes (initial value is zero) in the conversation content table.

In steps S109 and S110, the second communication unit 31 transmits the language information IDs, the language information, and the input times to the terminal device 1a and the other terminal devices 1b and 1c.

In steps S111 and S112, the first communication unit 11 of each of the terminal device 1a and the other terminal devices 1b and 1c receives the language information IDs, the language information, and the input times, and the first display control unit 16 additionally displays new language information in the conversation accumulation area 101. The input time may not be included, but the input time is used for highlighting the language information corresponding to the content selected in the whiteboard work area 102.

Since the state of the conversation accumulation area 101 has changed, the time-series storage processing unit 21 acquires the language information ID currently displayed in the conversation accumulation area 101 as the state of the conversation accumulation area 101. The time-series storage processing unit 21 acquires the content currently displayed in the whiteboard work area 102 as the state of the whiteboard work area 102 (the content data may be acquired from the information processing apparatus 3 or may be acquired from content displayed in the terminal device 1). The time-series storage processing unit 21 stores the state of the conversation accumulation area 101 and the state of the whiteboard work area 102 in the content display time-series storage unit 1001 in association with each other.

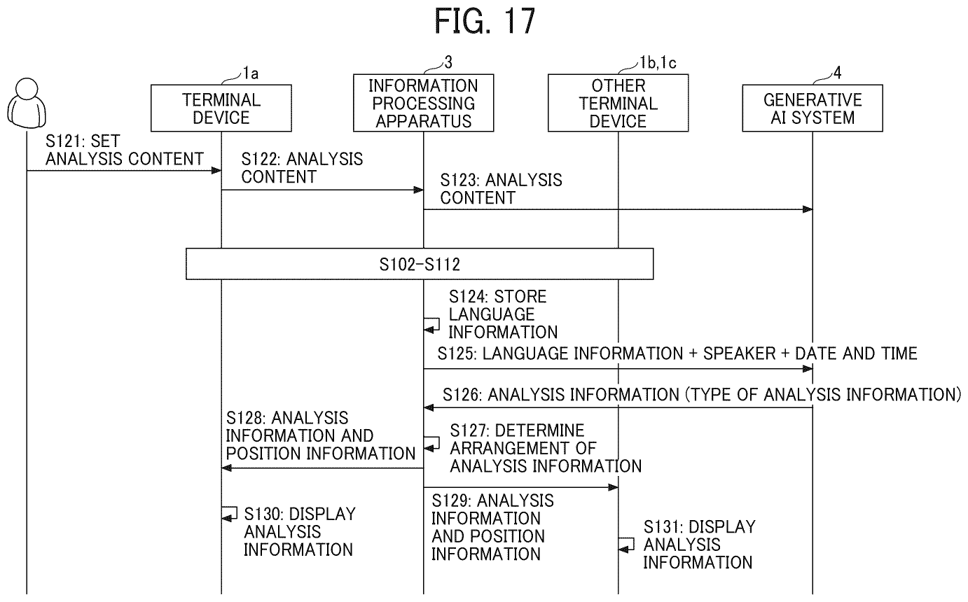

A description is given below of a processing flow in which each terminal device 1 participating in the conference displays analysis information generated by the generative AI system 4 analyzing language information with reference to FIG. 17. FIG. 17 is a sequence diagram illustrating a process in which the terminal devices 1 display analysis information generated by the generative AI system 4 analyzing language information in a whiteboard work area 102.

In step S121, the participant operates the terminal device 1a to set the analysis content on the second setting screen 260. The operation reception unit 18 of the terminal device 1a receives the setting of the participant. The second setting screen 260 can be set before the start of the conference or during the conference. When the range of date and time is set on the first setting screen 250, the setting content is also transmitted to the information processing apparatus 3. The analysis information is displayed at the initial position of the analysis information set on the first setting screen 250.

In step S122, the first communication unit 11 transmits the analysis content to the information processing apparatus 3.

In step S123, the second communication unit 31 of the information processing apparatus 3 receives the analysis content, and the third communication unit 38 of the information processing apparatus 3 transmits the analysis content to the generative AI system 4. As described above, the analysis content may be transmitted only when the participant changes the analysis content. However, the analysis content may be transmitted together with the language information each time.

After that, each participant in the conference speaks, and steps S102 to S112 of FIG. 16 are repeatedly executed.

In step S124, when the language information in the range set in the analysis content is accumulated, the analysis information acquisition unit 37 of the information processing apparatus 3 transmits the language information (including the speaker and the date and time of each language information) to the generative AI system 4. The language information in the range set in the analysis content is determined by a time interval, the number of characters, or automatic determination (change of speaker or topic). In the case of keyword extraction, the language information is transmitted to the information processing apparatus 3 without being accumulated. The analysis information acquisition unit 37 detects the time interval, the number of characters, the change of speaker or the change of topic, and transmits the language information in a designated range to the generative AI system 4 in a lump.

When the time interval, the number of characters, or automatic determination is set, the language information may be transmitted to the generative AI system 4 without being accumulated. This is because the generative AI system 4 can determine the time interval, the number of characters, the change of speaker, and the change of topic. When the language information is not accumulated, the language information is transmitted to the generative AI system 4 each time, following step S107 of FIG. 16.

In step S125, the generative AI system 4 analyzes the language information based on the analysis content, generates analysis information, and returns the analysis information to the information processing apparatus 3. The type of analysis information is included in each of the analysis information.

In step S126, the analysis information acquisition unit 37 of the information processing apparatus 3 acquires the analysis information via the third communication unit 38.

In step S127, the analysis information arrangement unit 36 refers to the arrangement information table and determines the arrangement of the analysis information so that the analysis information do not overlap with the existing content. The analysis information arrangement unit 36 registers information about the analysis information in the content table.

In steps S128 and S129, the second communication unit 31 of the information processing apparatus 3 transmits the analysis information and the position information to the terminal device 1a and the other terminal devices 1b and 1c. The position information may be coordinates (the upper left corner and the size of the message box) of each piece of analysis information determined by the analysis information arrangement unit 36.

In steps S130 and S131, the first communication unit 11 of each of the terminal devices 1a to 1c receives the analysis information and the position information, and the second display control unit 17 displays the analysis information in the whiteboard work area 102 based on the position information.

As described above, the agenda and the topic are displayed in the whiteboard work area 102 as illustrated in FIG. 1.

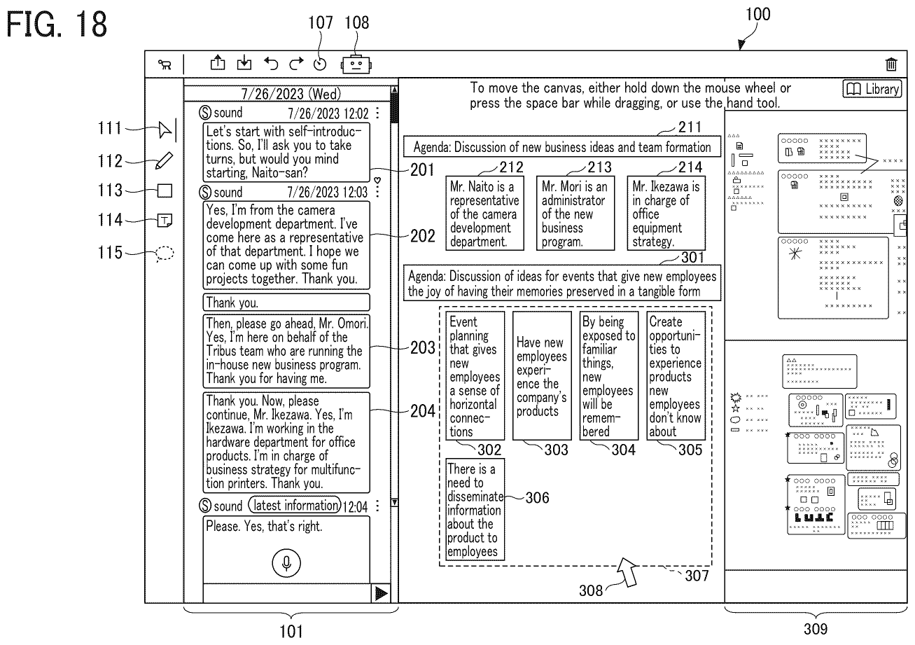

FIG. 18 is a diagram illustrating an arrangement of the analysis information displayed by the terminal device 1. In FIG. 18, the message boxes including the agenda 211 and the topics 212 to 214 illustrated in FIG. 1 are displayed. The message boxes including another agenda 301 and topics 302 to 306 are displayed. A combination of agenda and topic (e.g., agenda 211 and topics 212 to 214, agenda 301 and topics 302 to 306) is generated from language information in a range specified by the time interval, the number of characters, or the automatic determination. One message box includes only one type of analysis information, but even if the type of analysis information set on the second setting screen 260 is one, there may be multiple pieces of analysis information (topic or summary).

The same type of analysis information generated from the language information in the designated range may be grouped. For example, the second display control unit 17 displays a dotted line frame 307 surrounding the same type of analysis information as the analysis information mouse-overed by a mouse pointer 308 and prompt the participant to grasp the analysis information of the same group. Since the type of each piece of analysis information is transmitted from the information processing apparatus 3 to the terminal device 1, such grouping can be easily implemented.

In FIG. 18, there is no connection line indicating a hierarchical structure between one analysis information and the other analysis information, but the analysis information may be connected to each other with lines as illustrated in FIGS. 9 and 10. The participant may set whether to connect the line to the terminal device 1. Although the analysis information arrangement unit 36 determines the arrangement of the agenda 211 and the topics 212 to 214, the participant can move any message boxes.

The message box may not be visible, and the analysis information may be arranged in a transparent message box. The participant can also set a font, a font size, and a color of the analysis information in the message box.

In this way, as the conference progresses, the analysis information (and other content) is increasingly arranged in the whiteboard work area 102. When the analysis information overlaps with the existing content, the participant's understanding of the information is hindered. Therefore, the analysis information arrangement unit 36 controls the arrangement of the analysis information so that the analysis information does not overlap with the existing content based on the coordinates and the size (recorded in the content table) of the existing content. A content 309, which is a reduced content, is displayed on the right side of the whiteboard work area 102 in FIG. 18. The participant can reduce or enlarge the content of the conference which has been finished once to any size. The analysis information arrangement unit 36 can control the arrangement of the analysis information so that the analysis information does not overlap with the reduced content 309.

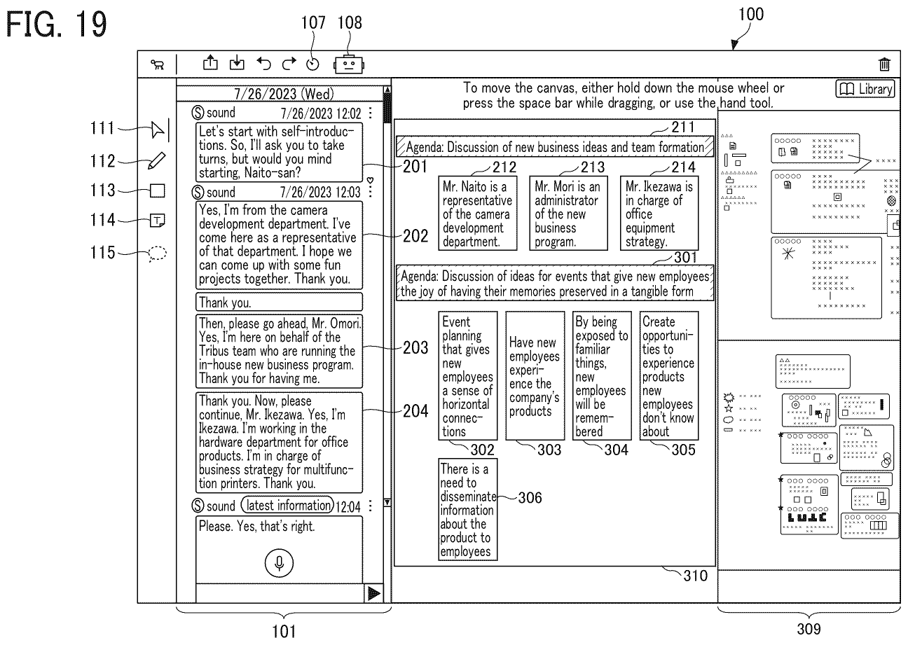

As illustrated in FIG. 19, an area 310 in which the analysis information is arranged may be designated by the participant. FIG. 19 is a diagram illustrating the area 310 in which the analysis information is arranged. In FIG. 19, the display position of the analysis information is set as the area 310. Accordingly, it can prevent the content of the whiteboard work area 102 from being complicated. The participant can set the area 310 with a pointing device such as a mouse.

Even when the area 310 is set, the analysis information arrangement unit 36 of the information processing apparatus 3 can arrange the analysis information. When the area 310 is set, the second display control unit 17 of the terminal device 1 converts the position information transmitted from the information processing apparatus 3 into coordinates in the area 310 and displays the analysis information. For example, the second display control unit 17 determines the position of the upper left corner of new analysis information to be displayed so that the new analysis information does not overlap the analysis information already displayed in the area 310. Then, the second display control unit 17 determines whether the new analysis information can be arranged in the area 310 when the new analysis information is arranged at the determined position of the upper left corner. When the analysis information protrudes in the width direction, for example, the number of stages of the arrangement information is increased to adjust the arrangement information so that the analysis information does not protrude. As a result, the second display control unit 17 can arrange the analysis information in the area 310 while maintaining the relative position between pieces of the analysis information (the relative position between the agenda and the topic) as much as possible.

The terminal device 1 may transmit the coordinates of the area 310 to the information processing apparatus 3. The analysis information arrangement unit 36 of the information processing apparatus 3 identifies the content in the area 310 in the content table, and determines the arrangement of the new analysis information so that the new analysis information is fit within the area 310.

The second display control unit 17 preferably displays the analysis information in a display mode corresponding to the type of the analysis information. The display mode refers to a bold character, a highlighted color, a large character size, surrounding the analysis information with a graphic, or changing the shape of the surrounding graphic. Such display mode is also referred to as highlighting. For example, in FIG. 19, the background of the agendas 211 and 301 is colored. The participant can easily pay attention to the agendas 211 and 301 having a high importance. The second display control unit 17 may change the color of the characters or the background for each type of analysis information. The participant can identify the type of the analysis information by the color.

In FIG. 19, the names of the topic are underlined. As described above, the second display control unit 17 can emphasize the analysis information in units of character strings. The second display control unit 17 may emphasize the name or a keyword that frequently appears by underlining, bold, or an emphasis color. The name and the keyword may be detected by any one of the information processing apparatus 3, the terminal device 1, and the generative AI system 4. In the case where the information processing apparatus 3 detects the name and the keyword, the information processing apparatus 3 designates the type of analysis information for each piece of analysis information, and further designates a proper noun (name) and a keyword that frequently appears. The second display control unit 17 of the terminal device 1 may change the color of the analysis information according to the type of the analysis information, and underlines the proper noun or displays the proper noun in a predetermined color.

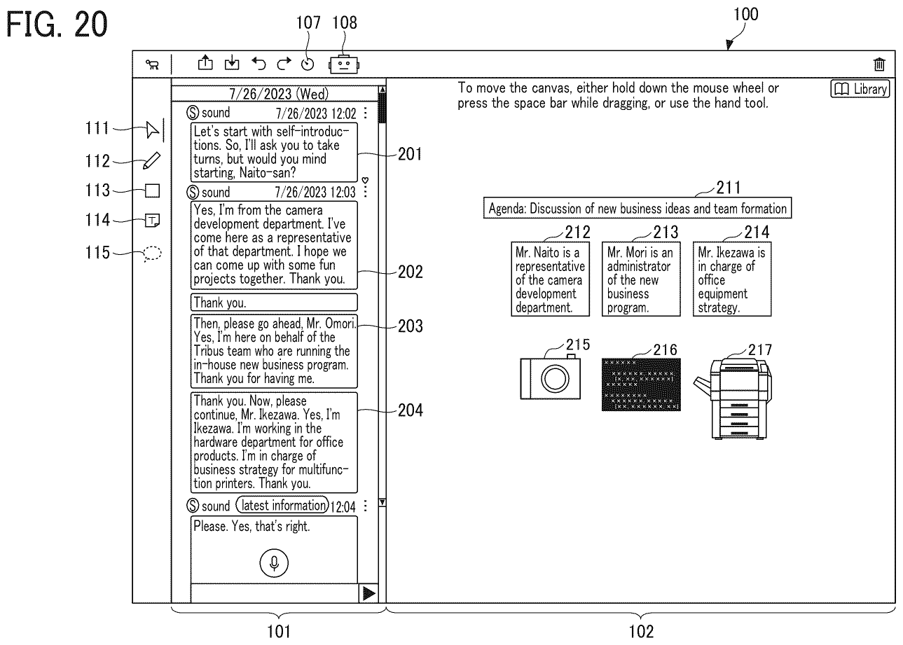

A description is given below of an illustration displayed based on the analysis information with reference to FIG. 20. FIG. 20 is a diagram illustrating the illustration displayed together with the analysis information in the whiteboard work area 102. When the radio button of the illustration setting field 262 is selected on the second setting screen 260, the illustrations related to the analysis information arranged in the whiteboard work area 102 are automatically displayed. In FIG. 20, an illustration 215 generated from the topic 212 is displayed under the topic 212, an illustration 216 generated from the topic 213 is displayed under the topic 213, and an illustration 217 generated from the topic 214 is displayed under the topic 214. An illustration may be displayed for the agenda 211 in the same manner.

A method of displaying the illustrations 215 to 217 is described below. A morphological analysis unit 14 breaks down the analysis information (topic in this case) into only Chinese characters or a character string by morphological analysis one by one, and the search unit 15 searches on the illustration storage unit 1002. The second display control unit 17 displays the illustrations suitable for the search around (below in the drawing) the topics 212 to 214. The display position of the illustration is determined so that the illustration does not overlap with other contents. A part of the illustrations 215 to 217 may overlap the topics 212 to 214.

The method of acquiring the illustration is not limited to the search of the illustration storage unit 1002. For example, the search unit 15 may acquire the illustration by the following method. A first method is a method of searching on the illustration storage unit 1002 or the Internet (search engine) for the illustration having a high degree of similarity to the illustration suitable for the search on the illustration storage unit 1002. A second method is a method of searching for an image on the Internet using the character string acquired by morphological analysis. A third method is a method of transmitting the character string acquired by morphological analysis to the generative AI system 4 and causing the generative AI system 4 to generate an image. Alternatively, the information processing apparatus 3 acquires the illustration together with the analysis information from the generative AI system 4.

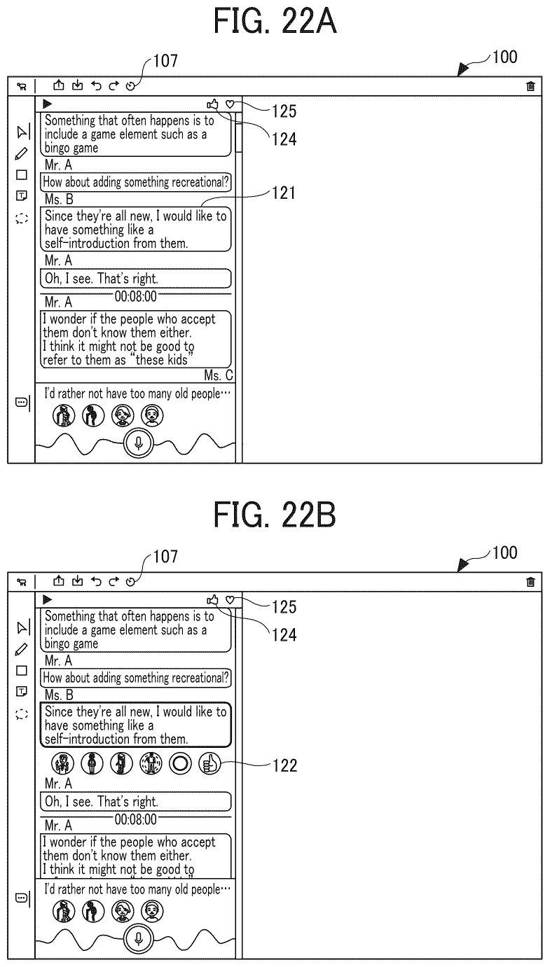

As a result, since the illustrations 215 to 217 are displayed, the participant can easily understand the content of the language information than when only the agenda and the topic are arranged. The second display control unit 17 may temporarily display an illustration list (see FIG. 22) instead of displaying only one of the illustrations 215 to 217 for each of the topics 212 to 214 as illustrated in FIG. 20. The participant can select a desired illustration from the illustration list.

In the arrangement information tables illustrated in FIGS. 9 and 10, the arrangement of the analysis information is determined by the analysis content, but the content and the arrangement of each analysis information may be modeled by machine learning. The model is modeled by deep learning in which, for example, the number of each type of analysis information is input and identification information of arrangement information (arrangement number in the arrangement information table) is output as a correct answer. This model outputs the probability that the arrangement information registered in advance as illustrated in FIGS. 9 and 10 is selected in response to the input of the number of each type of the analysis information.

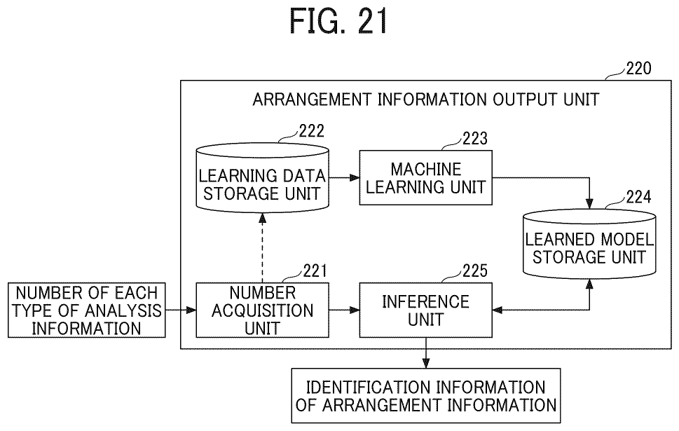

FIG. 21 is a functional block diagram of an arrangement information output unit 220 using machine learning. As illustrated in FIG. 21, the arrangement information output unit 220 may include a number acquisition unit 221, a learning data storage unit 222, a machine learning unit 223, a learned model storage unit 224, and an inference unit 225. A description is given below of the number acquisition unit 221, the learning data storage unit 222, the machine learning unit 223, the learned model storage unit 224, and the inference unit 225.

The number acquisition unit 221 acquires the number of pieces of analysis information for each type generated by the generative AI system 4. For example, when the number of agenda is one and the number of topics is three, the number acquisition unit 221 acquires “agenda: 1, topic: 3, summary: 0, divergence: 0, convergence: 0.” The learning data storage unit 222 stores learning data for machine learning. The learning data in the learning data storage unit 222 includes the number (input) of pieces of analysis information for each type, which is acquired and accumulated by the number acquisition unit 221 for a certain period, and the identification information (output) of the arrangement information corresponding to the analysis information.

The machine learning unit 223 generates a learned model in which the correspondence between the number (input) of pieces of analysis information for each type and the identification information (output) of the arrangement information corresponding thereto is learned. The machine learning unit 223 stores the generated learned model in the learned model storage unit 224. The learned model storage unit 224 stores the learned model generated by the machine learning unit 223.

The inference unit 225 acquires the number of pieces of analysis information generated by the generative AI system 4 for each type from the number acquisition unit 221 and infers the identification information of the arrangement information. Specifically, the inference unit 225 acquires the number of pieces of analysis information for each type from the number acquisition unit 221. The inference unit 225 inputs the number of pieces of analysis information for each type to the learned model in the learned model storage unit 224 and outputs identification information of the arrangement information.

The information processing apparatus 3 may acquire the arrangement information together with the analysis information from the generative AI system 4 instead of determining the arrangement information.

A description is given below of a method of displaying the illustration in the conversation storage area with reference to FIGS. 22A to 22D. FIGS. 22A to 22D are schematic diagrams illustrating a process in which the terminal device 1 displays the illustration based on language information in a conversation accumulation area 101. In FIGS. 22A to 22D, an operation is described in which the participant manually displays the language information displayed in the conversation accumulation area 101 in the whiteboard work area 102 without performing analysis by the generative AI system 4.

FIG. 22A illustrates the language information displayed in the conversation accumulation area 101. In FIG. 22A, the whiteboard work area 102 does not include any content yet, but may include a content. The participant selects (taps or clicks) any language information (language information 121 in this case) in the conversation accumulation area 101 for use in the whiteboard work area 102. The selected language information 121 is broken down into only Chinese characters or a character string by morphological analysis one character by one character, and the search unit 15 searches on the illustration storage unit 1002. The same method as that in FIG. 20 can be employed as the method of acquiring the illustration.

Accordingly, as illustrated in FIG. 22B, the first display control unit 16 of the terminal device 1 displays an illustration list 122 related to the language information around the selected language information 121 in the conversation accumulation area 101. The illustration list 122 is a thumbnail of the multiple illustrations (there may be one illustration).

The participant can select the illustration to be displayed in the whiteboard work area 102 from the illustration list 122. The participant may drag and drop the selected illustration in the whiteboard work area 102. Alternatively, the participant may simply select an illustration in the illustration list 122 to display the illustration in the whiteboard work area 102.

The participant can select the illustration from the illustration list 122 for the speech of other participants in addition to the content of the speech of the participant. Accordingly, other participants feel that their speech have been used, and feel a sense of active participation. In FIG. 22B, it is assumed that the participant does not select the illustration.

The terminal device 1 may store the illustration displayed for the language information displayed in the voice recognition result display field 110 and display the illustration as the illustration list 122. Accordingly, the time from when the participant selects the language information 121 to when the illustration list 122 is displayed can be reduced.

As illustrated in FIG. 22C, the participant selects a character string 123 which is a part of the language information, and drags and drops a copy of the character string 123 (referred to as a character string 126) from the conversation accumulation area 101 to the whiteboard work area 102. FIG. 22D illustrates the character string 126 displayed in the whiteboard work area 102. The participant can understand how the speech of participant effects the whiteboard work area 102.

The participant can click on a part or the whole of the character string 126 and then click on the whiteboard work area 102 to display the character string 123. The illustrations in the illustration list 122 may be displayed in the whiteboard work area 102 by either drag-and-drop or click.

As described above, the participant can use the language information in the conversation accumulation area 101 to reduce the input work to the whiteboard work area 102. The participant can further move the character string 126 or rotate the character string 126 to an any angle. The search unit 15 may automatically search the illustration storage unit 1002 for the character string 126 moved to the whiteboard work area 102, and the second display control unit 17 may display the illustration 127. Alternatively, the participant may manually display the illustration 127.

As illustrated in FIG. 22A, a like button 124 and a favorite button 125 are displayed for each piece of language information in the conversation accumulation area 101. The like button 124 and the favorite button 125 may be displayed at all times or may be displayed when the participant selects the language information or performs mouse-over. When the participant presses the like button 124, the language information ID and information indicating that the like button has been pressed are transmitted to the information processing apparatus 3, and the number of likes in the conversation content table is incremented by one. When the participant presses the favorite button 125, the language information ID is recorded in association with the participant ID.

As illustrated in FIG. 22D, when the content is added to the whiteboard work area 102, the update notification unit 19 of the terminal device 1 transmits the type, page, coordinates, size, font size, and language information ID of the content to the information processing apparatus 3 via the first communication unit 11 of the terminal device 1. Since the content management unit 34 of the information processing apparatus 3 transmits one record of the newly added content table to the other terminal devices 1b and 1c, the other terminal devices 1b and 1c can share the state of the whiteboard work area 102.

When the illustration list 122 as illustrated in FIGS. 22A to 22D is displayed, the first display control unit 16 may determine the display order of the thumbnails in the illustration list 122 according to the original language information 121.

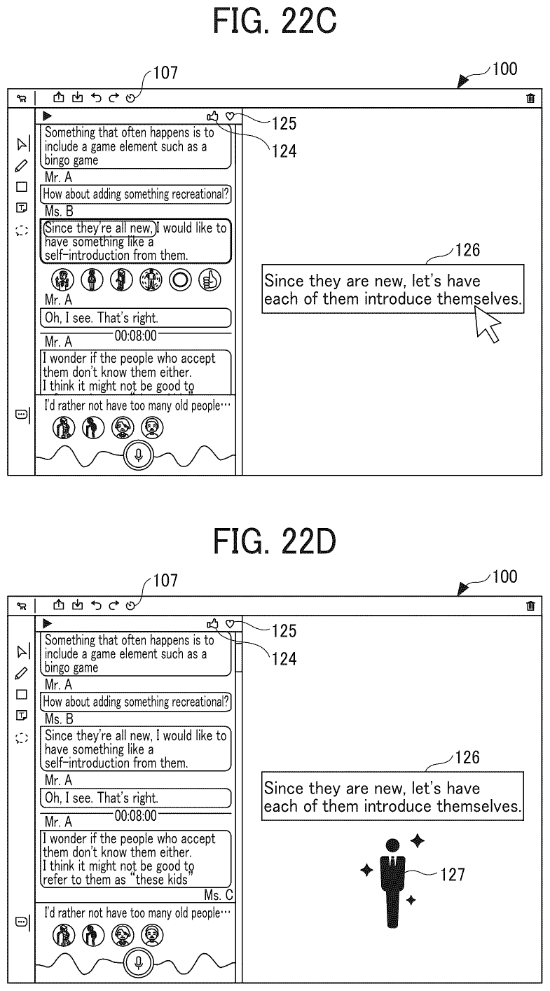

FIGS. 23A and 23B are diagrams illustrating the display order of thumbnails of illustrations determined in accordance with language information. FIGS. 23A and 23B illustrate how the order of display of thumbnails changes depending on different language information.

The first display control unit 16 performs morphological analysis on the language information and searches the illustration table in order from the first word among multiple words acquired by the morphological analysis. The first display control unit 16 extracts an illustration matching the word and displays the illustration as an individual thumbnail in the illustration list. In this case, when multiple illustrations match one word in the illustration table and the first display control unit 16 arranges all of the illustrations as thumbnails in the illustration list, the limited display area of the illustration list is filled with the thumbnails of the illustrations related to one word. In order to prevent this, the first display control unit 16 displays one thumbnail and one word for one sentence of the language information (an example of the language information of a predetermined unit). When the thumbnail of the illustration is displayed for one sentence, the first display control unit 16 returns to the beginning of the sentence and displays the rest of the thumbnail.

FIG. 23A illustrates an illustration list 230 displayed for language information 239 indicating “person who likes animal” spoken by the participant. The words detected by the morphological analysis are “animal”, “like”, and “person” in this order. Since the first display control unit 16 displays one thumbnail per word, a thumbnail 231 corresponding to the “animal”, a thumbnail 232 corresponding to the “like”, and a thumbnail 233 corresponding to the “person” are displayed in this order in FIG. 23A. When the thumbnail of the illustration is displayed for one sentence, the first display control unit 16 returns to the beginning of the sentence and displays the rest of the thumbnail. Accordingly, in FIG. 23A, a thumbnail 234 corresponding to the “animal”, a thumbnail 235 corresponding to the “like”, a thumbnail 236 corresponding to the “person”, a thumbnail 237 corresponding to the “animal”, and a thumbnail 238 corresponding to the “like” are continuously displayed in this order.

FIG. 23B illustrates an illustration list 240 displayed for language information 249 “I like people and animals” spoken by the participant. The words detected by the morphological analysis are “person”, “animal”, and “like” in this order. The order of appearance of the words is different from FIG. 23A. Accordingly, in FIG. 23B, a thumbnail 241 corresponding to the “person”, a thumbnail 242 corresponding to the “animal”, a thumbnail 243 corresponding to the “like”, a thumbnail 244 corresponding to the “person”, a thumbnail 245 corresponding to the “animal”, a thumbnail 246 corresponding to the “like”, a thumbnail 247 corresponding to the “person”, and a thumbnail 248 corresponding to the “animal” are displayed in this order.

Such display control of the thumbnails in the illustration list can be similarly performed in the whiteboard work area 102.

The first display control unit 16 may display multiple thumbnails for one word as long as the display area of the illustration list is not filled with the thumbnails of illustrations related to one word. The first display control unit 16 may perform morphological analysis on multiple sentences at once and display illustrations common to words detected as a result of the morphological analysis.

The participant uses the content of the whiteboard work area 102 as an output. However, since the analysis information generated by the generative AI system 4 is automatically displayed, the participant may not want to display all pieces of analysis information in the whiteboard work area 102. The contents of the whiteboard work area 102 are likely to increase and thus be complicated. Since the participant uses the whiteboard work area 102 as a whiteboard, the participant may want to arrange only the content input by the participant with intention.

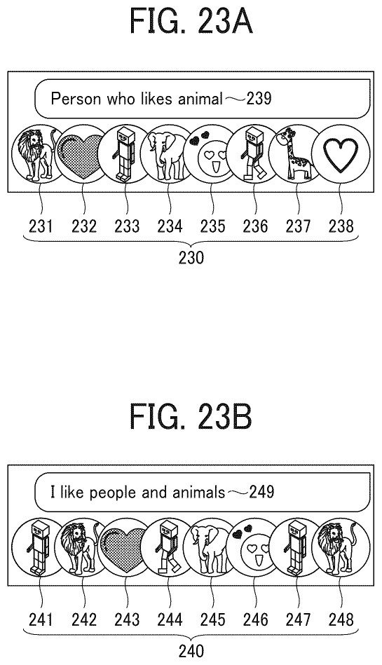

A description is given below of a use case in which a temporary area 330 (a third area) is used with reference to FIG. 24. FIG. 24 is a diagram illustrating the information display screen 100 including the temporary area 330, which is displayed by the terminal device 1 during the conference. The analysis information transmitted from the information processing apparatus 3 is collectively displayed in the temporary area 330. In this case, the method of determining the arrangement of the analysis information may be the same as that in the case where the area 310 is set.

The participant can confirm the analysis information in the temporary area 330 and drag and drop the analysis information into the whiteboard work area 102 with a mouse. In this way, the participant can easily move the analysis information from the temporary area 330 to the whiteboard work area 102. The analysis information in the temporary area 330 may be deleted (moved) or may be left as it is (copied).

In FIG. 24, the topics 212 to 214 and the topics 302 and 306 are copied from the temporary area 330 to the whiteboard work area 102. Since it is troublesome for the participant to copy each piece of analysis information, the analysis information may be moved, for example, for each type of analysis information. For example, the second display control unit 17 displays a dotted line frame 311 surrounding the same type of analysis information as the analysis information mouse-overed by the mouse pointer 308, and the participant can move the same type of analysis information to the whiteboard work area 102 together with the dotted line frame 311.

In FIG. 24, language information 312 and 314, and illustrations 313 and 315 are displayed in the whiteboard work area 102. The language information 312 and 314 may be input by the participant. Alternatively, the language information 312 and 314 may be copied from the conversation accumulation area 101. The illustrations 313 and 315 are displayed by searching, for example, for the language information 312 and 314 on the illustration storage unit 1002.

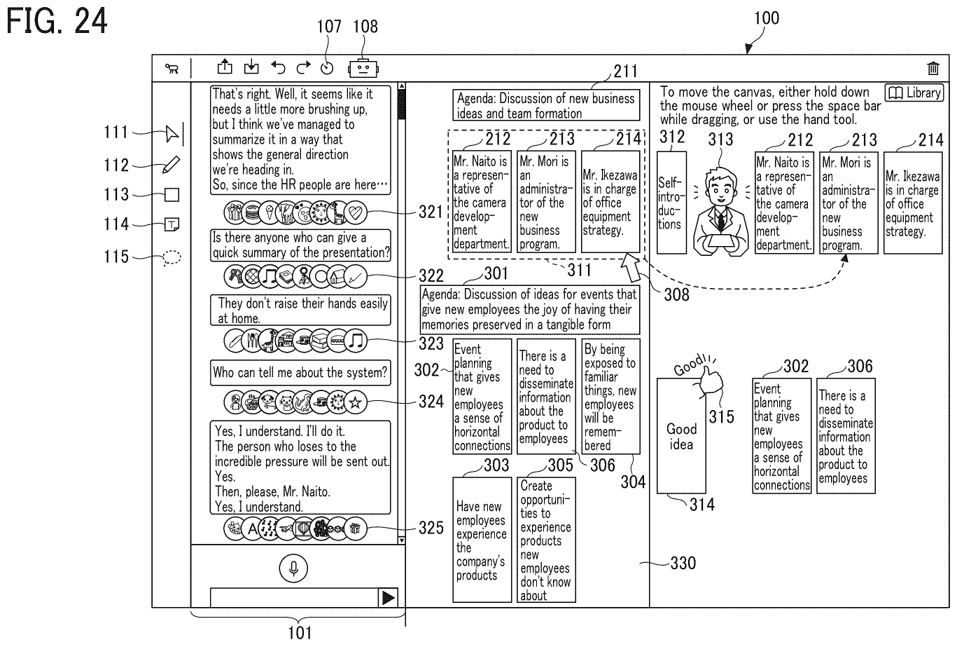

In FIG. 24, as described in FIG. 22, the illustration lists 321 to 325 corresponding to the language information are displayed in the conversation accumulation area 101. Such illustration lists 321 to 325 corresponding to the analysis information can be also displayed in the temporary area 330 as illustrated in FIG. 25.

FIG. 25 is a diagram illustrating the information display screen 100 on which an illustration list 341 is displayed in the temporary area 330. When the participant designates any analysis information, the search unit 15 searches, for example, for the analysis information on the illustration storage unit 1002, and the second display control unit 17 displays the illustration list 341. The illustration list 341 may be displayed in the same manner as the conversation accumulation area 101. The participant can drag and drop any illustration in the illustration list 341 into the whiteboard work area 102.

A summary image 342 in the temporary area 330 is an image generated by the generative AI system 4 when the summary is set in the analysis content. In this way, the analysis information may be directly acquired as an image. The participant can drag and drop the summary image 342 into the whiteboard work area 102.

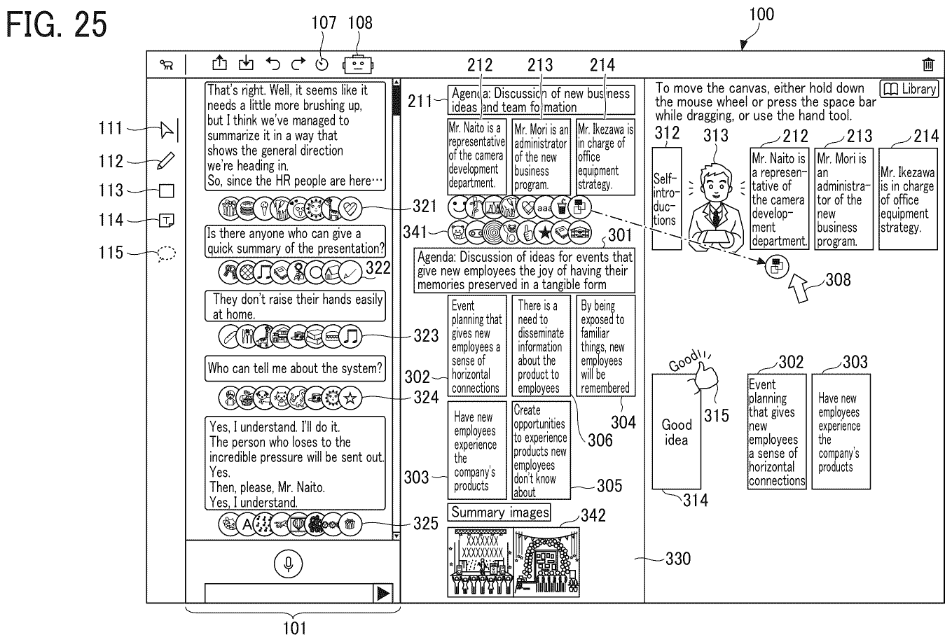

FIG. 26 is a sequence diagram of a process in which the terminal device 1a copies the analysis information from the temporary area 330 to the whiteboard work area 102 in response to an operation by the participant.

In step S141, the participant drags and drops the analysis information in the temporary area 330 to the whiteboard work area 102.

In step S142, the operation reception unit 18 receives an operation of dragging and dropping the analysis information in the temporary area 330 to the whiteboard work area 102.

In step S143, the update notification unit 19 detects that the state of the whiteboard work area 102 has been changed. The update notification unit 19 transmits an update notification (temporary content ID) of the content to the information processing apparatus 3 via the first communication unit 11.

The analysis information is initially displayed in the temporary area 330 and is registered in the content table for the temporary area 330. This content table may be the same as the content table illustrated in FIG. 6. The temporary content ID is the content ID of the content table for the temporary area 330.

In step S144, the second communication unit 31 of the information processing apparatus 3 receives the update notification of the content, and the content management unit 34 numbers the content ID. The content management unit 34 registers information on the analysis information designated by the temporary content ID in the content table together with the content ID. When the analysis information is deleted from the temporary area 330, the content management unit 34 deletes information related to the deleted analysis information from the content table for the temporary area 330.

In step S145, the second communication unit 31 of the information processing apparatus 3 transmits the new content ID to the terminal device 1.

In step S146, since the content table has been changed, the content management unit 34 transmits a request to share the content (content ID, content type, analysis information, page, coordinates, size, font size, and language information ID) to the other terminal devices 1b and 1c participating in the same conference.

In step S147, the first communication unit 11 of each of the other terminal devices 1b and 1c receives the request to share the content, and the second display control unit 17 displays the analysis information at the position designated by the coordinates in the font size.

The display unit that displays the conversation accumulation area 101 and the whiteboard work area 102 according to the present embodiment can be implemented by a head-mounted display (HMD).

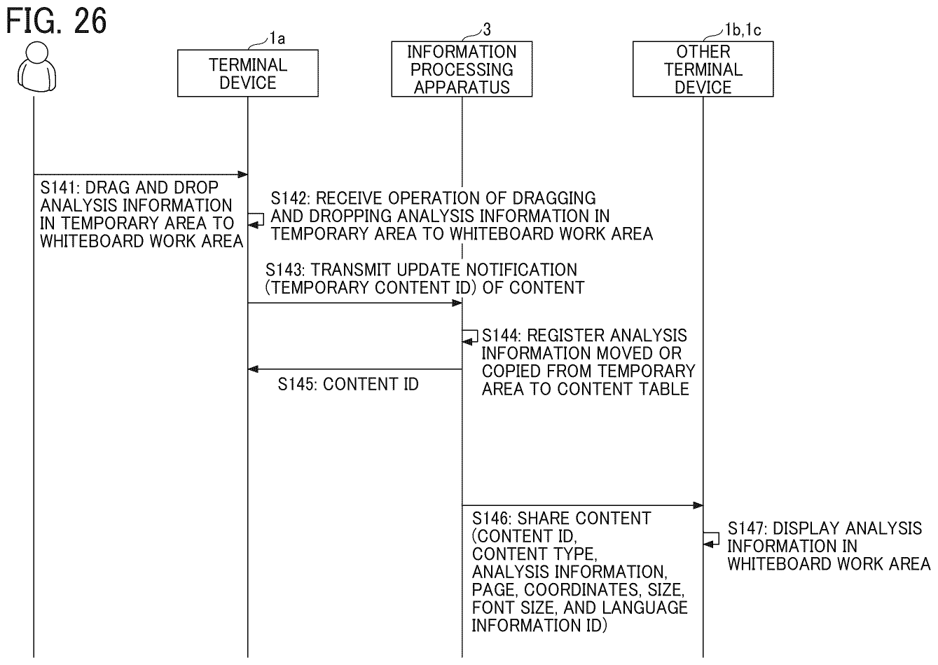

FIG. 27 is a hardware block diagram of the HMD. As illustrated in FIG. 27, the HMD include, as computer, a CPU 401, a ROM 402, a RAM 403, an electronic compass 404, a gyro sensor 405, an accelerometer 406, an external device connection I/F 407, a display 408, an operation unit 409, a medium I/F 410, and a speaker 412. These units are connected to a bus line 415.

The CPU 401 controls the overall operation of the HMD. The ROM 402 stores programs including an initial program loader (IPL) to boot the CPU 401. The RAM 403 is used as a work area for the CPU 401.

The external device connection I/F 407 is an interface that connects the HMD to various external devices. The external device in this case is the information processing apparatus 3.

The display 408 is an example of a display device that displays various images.

Examples of the display 408 include, but are not limited to, a liquid crystal display (LCD) and an organic electroluminescence (EL) display.

The operation unit 409 is an input unit for selecting and executing various instructions, selecting a processing target, and moving a cursor, such as various operation buttons, a power switch, a physical button, and a line-of-sight operation circuit that detects and operates the line of sight of the participant.

The medium I/F 410 controls the reading or writing (storing) of data from or to a recording medium 411 such as a flash memory. Examples of the recording medium 411 include a digital versatile disc (DVD) and a Blu-ray Disc™.

The speaker 412 is a circuit that generates sound such as music or voice by converting an electrical signal into physical vibration.

The electronic compass 404 calculates an orientation of the HMD from the Earth's magnetism to output orientation information.

The gyro sensor 405 is a sensor that detects the change in tilt (roll, pitch, and yaw) with movement of the HMD.

The accelerometer 406 detects acceleration in three axial directions.

The bus line 415 is an address bus and a data bus for electrically connecting the components such as the CPU 401.

In the communication system according to the present embodiment, the agenda and the topic in the conference are automatically displayed in the whiteboard work area 102. As a result, the burden on the participant can be reduced and the participant can easily grasp the idea and the flow of the discussion. Since the range of the language information is designated, the analysis information to be displayed can be limited. As a result, the participant can grasp only useful information. The communication system extracts ideas included in the communication and organizes the flow of discussion based on the analysis content set by the participant. As a result, the burden on the participant in the communication can be reduced. Since an illustration can be displayed in the analysis information, the participant can more easily grasp the content and flow of the discussion.

Second Embodiment In the present embodiment, the communication system 5 that displays an analysis result acquired by analyzing language information by the generative AI system 4 in the conversation accumulation area 101 is described.

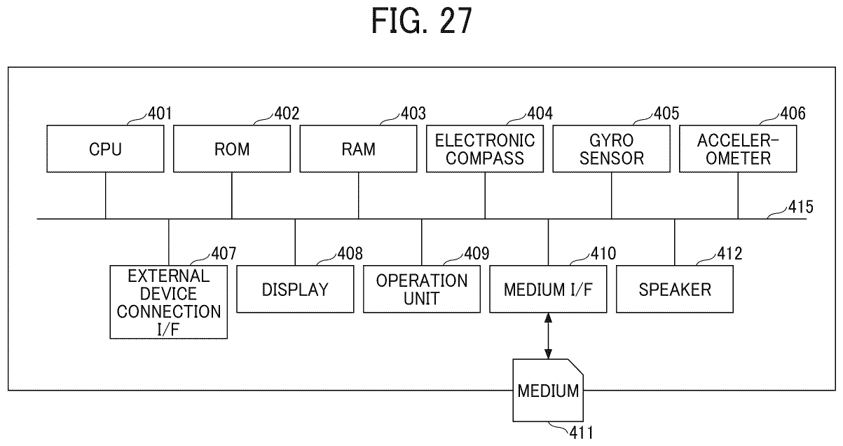

FIG. 28 is a functional block diagram of the communication system 5 in which functions are separately illustrated as blocks in the information processing apparatus 3 and the terminal device 1. In the following description, mainly the differences from FIG. 4 may be described with reference to FIG. 28.

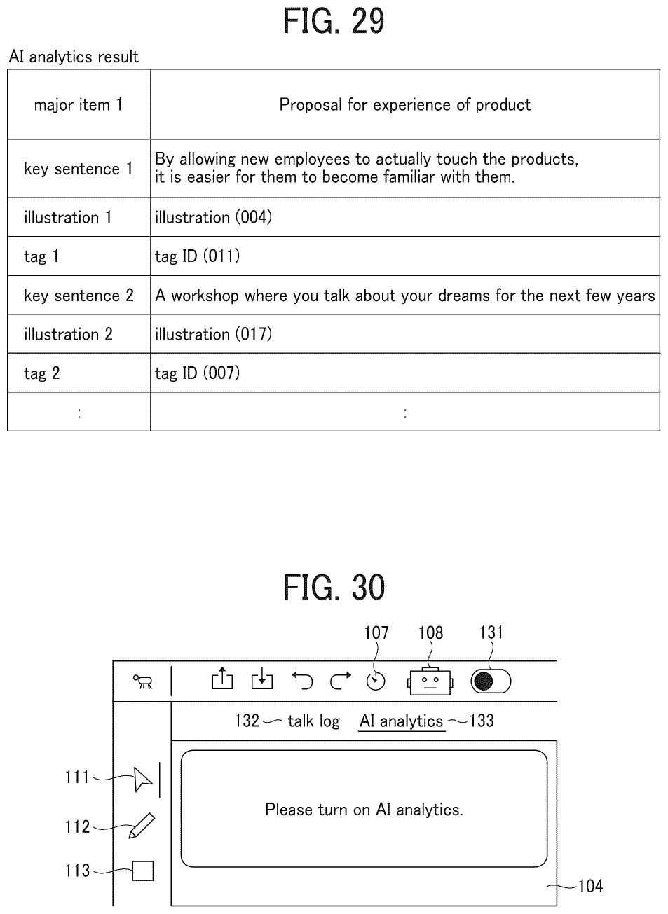

The terminal device 1 newly includes a third display control unit 22. The third display control unit 22 displays an AI analysis result in an AI analysis area 104 described in FIG. 30. The AI analysis result is information generated based on the result of analyzing the language information by the generative AI system 4. The terminal device 1 of FIG. 28 does not include the search unit 15 and the illustration storage unit 1002. This is because the generative AI system 4 determines the illustration in the present embodiment. However, even in an embodiment in which the generative AI system 4 determines the illustration, the search unit 15 may further search the illustration storage unit 1002 and the participant may select a desired illustration.

The terminal device 1 includes an AI analysis result storage unit 1004 in the storage unit 1000. The AI analysis result storage unit 1004 stores an AI analysis result acquired by the generative AI system 4 analyzing the language information. The information processing apparatus 3 may include the same AI analysis result storage unit 1004.

Similarly, the information processing apparatus 3 does not include the analysis information arrangement unit 36 and the arrangement information storage unit 3005. This is because, in the present embodiment, the generative AI system 4 arranges the analysis information, and the participant arranges the content using the template.

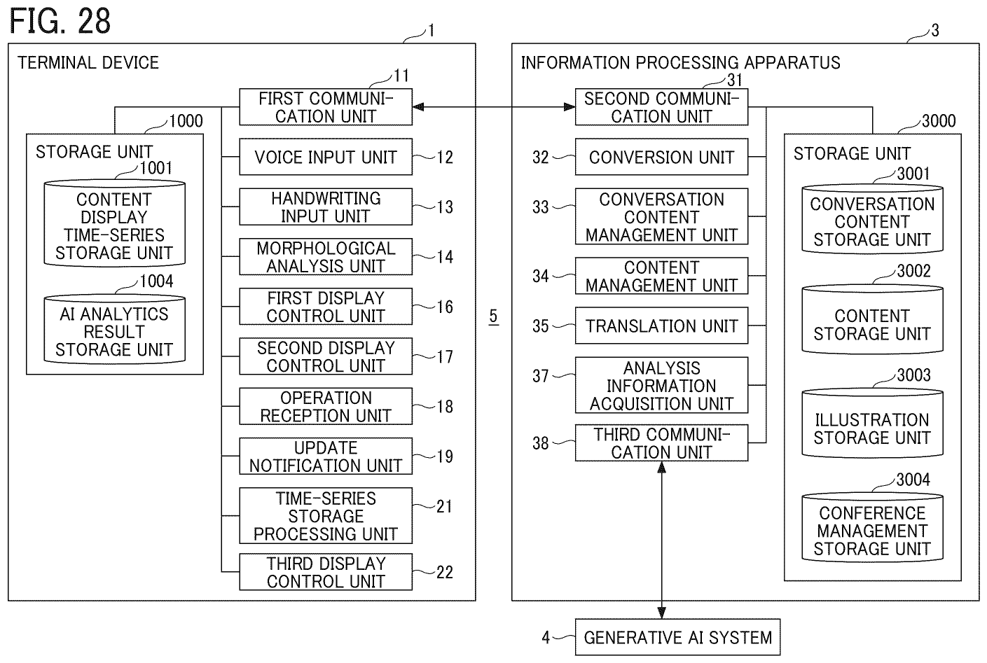

FIG. 29 is a schematic diagram illustrating the AI analysis result stored in the AI analysis result storage unit 1004. As described later, the AI analysis result storage unit 1004 stores one or more key sentences, illustrations, and tags in association with one major item. The number of major items is one or more, and one or more key sentences, illustrations, and tags are associated with one major item. One major item and one or more key sentences, illustrations, and tags form a combination. A detailed description is given later.

A description is given below of the AI analysis area 104 of the present embodiment with reference to FIGS. 30 to 33. FIG. 30 is a diagram illustrating a part of the AI analysis area 104. The AI analysis area 104 (a fourth area) is displayed at the same position as the conversation accumulation area 101, and the participant switches between the conversation accumulation area 101 and the AI analysis area 104. The participant uses tabs 132 and 133 to switch between the conversation accumulation area 101 and the AI analysis area 104. When the tab 132 is pressed, the conversation accumulation area 101 is displayed, and when the tab 133 is pressed, the AI analysis area 104 is displayed. However, the participant may be able to display the conversation accumulation area 101 and the AI analysis area 104 separately at the same time.

An operation for the setting performed by the participant for the AI analysis result to be displayed in the AI analysis area 104 is designed not to be burden for the participant. For example, in the present embodiment, the participant does not perform the settings described in FIGS. 14 and 15. For example, when the participant turns on the AI analysis function (turns on a toggle button 131 described later) once, the analysis information acquisition unit 37 determines a delimiter for a specific number of characters for the AI analysis, and transmits the language information to the generative AI system 4 via the third communication unit 38. The first communication unit 11 of the terminal device 1 receives the AI analysis result via the information processing apparatus 3, and the third display control unit 22 displays the AI analysis result in the AI analysis area 104 as appropriate. As described above, a detailed setting screen for the generative AI system 4 is not provided, and the setting prepared in advance by the system is applied.

The AI analysis function is turned on and off with the toggle button 131. In other words, when the participant selects the AI analysis in the tab 133 and turns on the toggle button 131, the AI analysis result is displayed in the AI analysis area 104. However, the third display control unit 22 may automatically display the AI analysis area 104 when the participant turns on the toggle button 131.

The toggle button 131 can be operated by the participant who participates in the conference as a manager (only a facilitator) of the conference. The facilitator is, for example, a person who leads the conference. The facilitator may be, for example, determined when the participant logs in and then the facilitator is fixed. Alternatively, the facilitator may be, for example, changed from participant to participant during the conference. Any participant may turn on or off the toggle button 131. In this case, it is preferable that a method of use in which all participants of the conference can confirm the same AI analysis result regardless of who has turned on the toggle button 131 and a method of use in which only the participant who has turned on the toggle button 131 can check the AI analysis result are prepared.

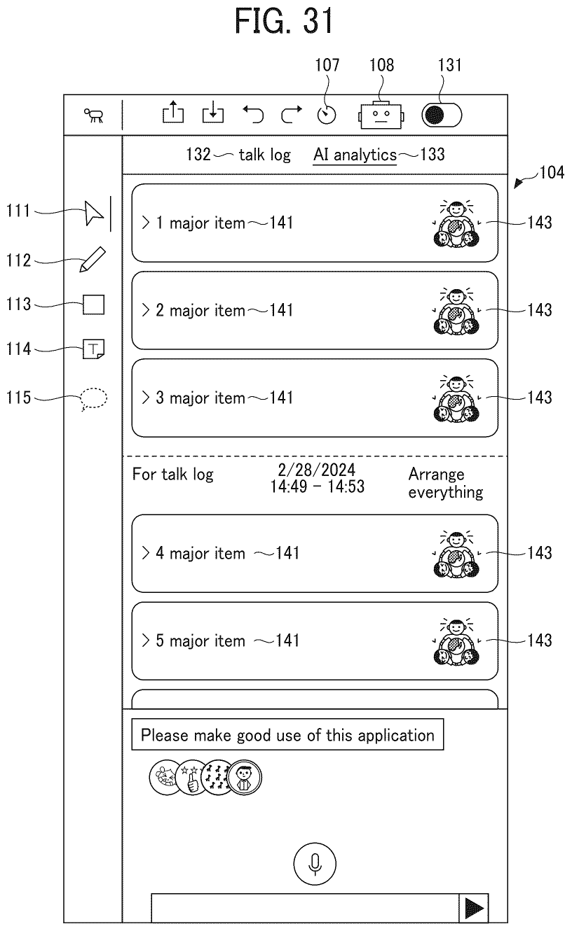

FIG. 31 is a diagram illustrating the AI analysis result displayed in the AI analysis area 104. In the AI analysis area 104, the major items 141 are displayed, and one or more key sentences 142 associated with the major item 141 are displayed. The major item 141 is a subject of language information. The major item 141 is information that corresponds to an agenda discussed in a conference and allows the user to understand the overall discussion. The key sentence 142 corresponds to a keyword determined to be important in the discussion, and is information extracted from the language information or information acquired by briefly summarizing the content of the discussion.

Although one type of major item 141 is displayed in FIG. 31, multiple types of major items 141 may be displayed. The generative AI system 4 automatically detects the change in the discussion and generates a new major item 141 based on the detection. The generative AI system 4 automatically determines the key sentence 142 determined to be important for the major item 141 and associates the key sentence 142 with the major item 141 until the major item 141 is switched.

As illustrated in FIG. 31, an illustration 143 is displayed in association with the major item 141. One illustration 144 is displayed in one-to-one correspondence with one key sentence 142. Although the illustration 144 is arranged on the right side of the key sentence 142 in FIG. 31, the position of the illustration 144 is merely an example. Multiple illustrations may be displayed in association with one key sentence 142. In the present embodiment, the illustrations 143 and 144 determined by the generative AI system 4 to represent the content of the major item 141 or the key sentence 142 is displayed.

Multiple illustrations are preferably registered in advance as options in the generative AI system 4. The information processing apparatus 3 may register the multiple illustrations as options in the generative AI system 4. Alternatively, the participant may designate the illustrations stored in the generative AI. Accordingly, the range of selection of illustrations by the generative AI system 4 is reduced and the same illustration is likely to be constantly displayed for the major item or the key sentence having similar content.

The participant can operate an open-close button 145 to switch between display and non-display of the key sentence 142 for each major item 141. Only the key sentence 142 of the major item 141 on which the participant is focusing can be displayed. Thus, even if the AI analysis area 104 is small, only the major item 141 on which the participant is focusing and the key sentence 142 of the major item 141 can be displayed.

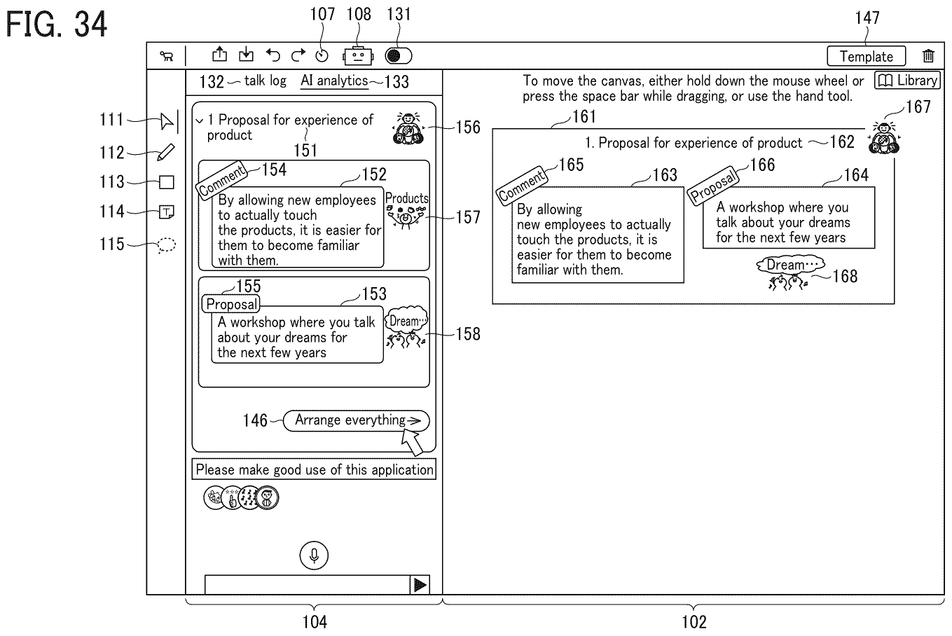

One major item 141 has one arrangement button 146. The arrangement button 146 is a button for displaying the major item 141 and all of the key sentences 142 associated with the major item 141 in the whiteboard work area 102. Details of this operation is described later with reference to FIG. 34. However, in the present embodiment, the participant can also drag and drop to display the major item and the key sentence in the whiteboard work area 102.

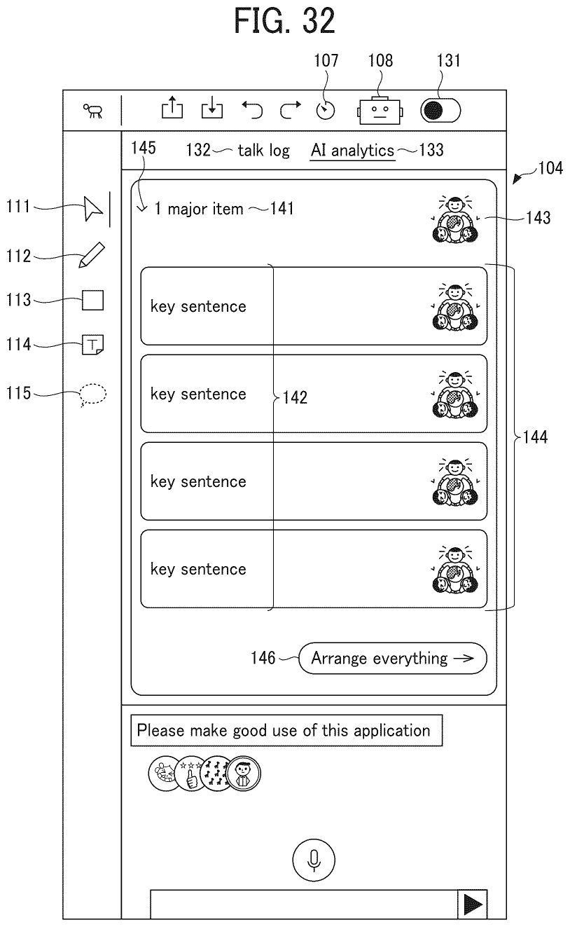

FIG. 32 is a diagram illustrating the AI analysis area 104 in which the multiple major items 141 are displayed. In FIG. 32, five major items 141 are displayed. The participant can scroll the AI analysis area 104 in the vertical direction to display the sixth and subsequent major items 141. The number of major items 141 displayed during the conference may vary depending on the content of the language information and whether the generative AI system 4 determines that the content of the discussion has changed. The major item 141 is added as appropriate in accordance with the progress of the discussion. When the major item 141 is added, the key sentence 142 is added as appropriate in association with the major item 141 in accordance with the progress of the discussion.

In FIG. 32, the key sentences 142 are not displayed due to the operation of the open-close button 145. In this state, the participant can comprehensively confirm only the major items 141.

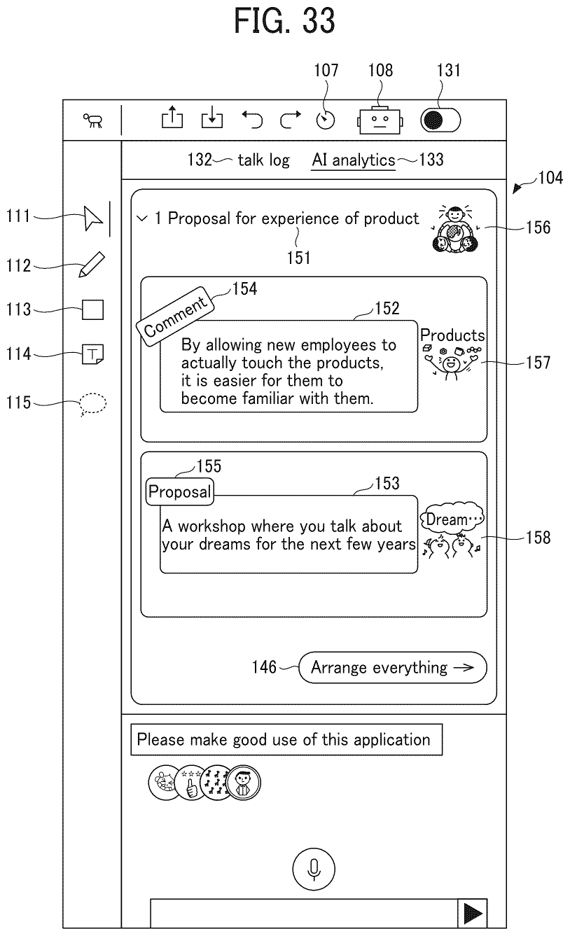

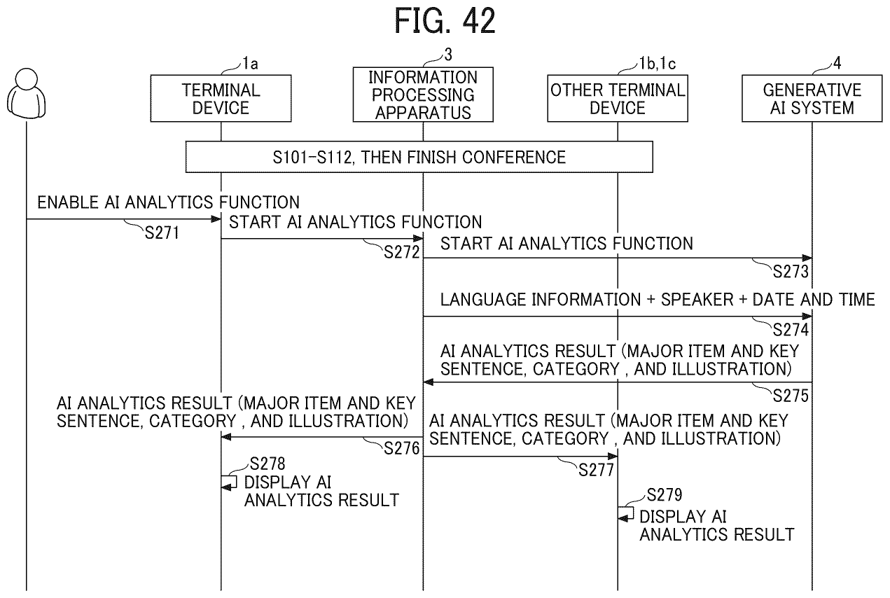

FIG. 33 is a diagram illustrating a major item and key sentences. A major item 151 in FIG. 33 is “Proposal for experience of product”, a first key sentence 152 is “By allowing new employees to actually touch the products, it is easier for them to become familiar with them.”, and a second key sentence 153 is “A workshop where you talk about your dreams for the next few years.” The generative AI system 4 can generate the major item 151 and the key sentences 152 and 153, and the third display control unit 22 can display the major item 151 and the key sentences 152 and 153 in the AI analysis area 104 as appropriate. The term “as appropriate” indicates that the major item 151 and the key sentences 152 and 153 are displayed at the timing when the generative AI system 4 generates the major item 151 and the key sentences 152 and 153 (immediately after the AI analysis is completed except for a delay due to communication). In addition to such a real-time usage, as described later with reference to FIG. 42, a usage in which the participant displays the AI analysis result after the end of the conference is also possible.

When the generative AI system 4 generates the key sentences 152 and 153, the generative AI system 4 classifies the content of the key sentences 152 and 153 and determines the category. In FIG. 33, a category 154 of the key sentence 152 is determined as “comment”, and a category 155 of the key sentence 153 is determined as “proposal”. The third display control unit 22 displays the categories 154 and 155 in association with the key sentences 152 and 153, respectively. The participant can confirm the categories 154 and 155 to grasp the content of the key sentences 152 and 153 or search for a target key sentence. For example, the participant can search for the key sentence using the category as a key, and can display a list of the key sentences determined to belong to the same category.

Although the categories 154 and 155 are arranged at the upper left of the key sentences 152 and 153 respectively in FIG. 33, the positions of the categories 154 and 155 are merely examples. The generative AI system 4 may set two or more categories for one key sentence.

FIG. 34 is a diagram illustrating a major item 162 and key sentences 163 and 164 displayed in the whiteboard work area 102 by pressing the arrangement button 146. When the participant presses the arrangement button 146, the major item 162 and the key sentences 163 and 164 are displayed in the whiteboard work area 102. In FIG. 34, two key sentences 163 and 164 are arranged in parallel under the major item 162. The major item 162 and the two key sentences 163 and 164 are surrounded by a frame 161. The frame 161 allows the participant to easily understand that the major item 162 and the two key sentences 163 and 164 belong to one group (highly related).

The generative AI system 4 can determine the shape of the frame 161. The shape of the frame 161 in FIG. 34 is rectangular. It is known that the shape of the frame, such as a curve, a rectangle, or a freehand, changes the impression given to the participant. The generative AI system 4 determines the shape of the frame 161 based on the content of the major item 162 and the key sentences 163 and 164 so that the participant can receive an impression corresponding to the content. The generative AI system 4 determines the shape of the frame 161 based on the following factors. The factors are the major item 162 and the key sentences 163 and 164, the major item 162 alone, key sentence determined to be important among the key sentences 163 and 164, category of both key sentences 163 and 164. In addition, the generative AI system 4 can also determine not only the shape of the frame 161 of the key sentence determined to be important among the key sentences 163 and 164, but also the type of frame line (solid line, dotted line, broken line, or double line), the color of the frame, the thickness of the frame, and the color in the frame from at least one of the major item 162 and the key sentences 163 and 164.

The generative AI system 4 can determine the font of the major item 162 and the key sentences 163 and 164 from at least one of the major item 162 and the key sentences 163 and 164.

The font may be determined in common for the major item 162 and the key sentences 163 and 164 in the frame 161. Alternatively, the font may be determined for each of the major item 162, the key sentences 163 and 164.

When the font is determined in common for the major item 162 and the key sentences 163 and 164 in the frame 161, the factors for the determination are considered to be the same as the factors for the determination of the shape of the frame.

When the font is determined for each of the major item 162 and the key sentences 163 and 164, the font of the major item 162 is determined by the major item 162, the font of the key sentence 163 is determined by the key sentence 163 or a category 165, and the font of the key sentence 164 is determined by the key sentence 164 or a category 166. When the key sentences 163 and 164 use the same font, the determination is made based on both of the key sentences 163 and 164, the key sentence determined to be important among the key sentences 163 and 164, or the category determined to be important among the category 165 and the category 166.

The shape of the frame, the type of the frame line, the color of the frame, the thickness of the frame, the color in the frame, and the font are referred to as “frame information”. The frame information may be determined for each frame displayed in the whiteboard work area 102. Alternatively, the frame information may be determined commonly for each the frame. When the frame information is determined commonly for each frame, the generative AI system 4 uses, for example, the most frame information as the frame information.

As illustrated in FIG. 34, an illustration 167 is displayed on the upper right of the frame 161 displayed in the whiteboard work area 102. The illustration 167 is the same illustration displayed in the AI analysis area 104 based on the major item 151. The participant can determine the content of the discussion in the frame 161 by the illustration 167. In FIG. 34, an illustration 168 is displayed at the lower right of the key sentence 164. The followings are conceivable as display modes of the illustration based on the key sentences 163 and 164. The illustrations displayed in the frame 161 may be the same as the illustrations displayed in the AI analysis area 104. The illustrations are displayed for both of the key sentences 163 and 164. The illustration is displayed for only the key sentence that is determined to be most important. The illustration is displayed for each key sentence determined to have a predetermined level of importance or more. No illustration is displayed for the key sentences.

In FIG. 34, the category 165 is displayed at the upper left of the key sentence 163, and the category 166 is displayed at the upper left of the key sentence 164. The followings are conceivable as display modes of the illustration based on the key sentences 163 and 164. The categories displayed in the frame 161 may be the same as the categories displayed in the AI analysis area 104. The categories are displayed for both of the key sentences 163 and 164. The category is displayed for only the key sentence that is determined to be most important. The category is displayed for the key sentence determined to have a predetermined level of importance or more. No category is displayed for the key sentences.

In FIG. 34, the major item 162 and the key sentences 163 and 164 are arranged in the frame 161. However, the generative AI system 4 may determine the relation between the major item 162 and the key sentences 163 and 164 and the relation between the key sentences 163 and 164, and thus the generative AI system 4 may connect the major item 162 and the key sentence 163 with a line or connect the key sentences 163 and 164 with a line. For example, as illustrated in the arrangement information table of FIG. 9, the connection relation and the arrangement are selected according to the analysis content of the major item 162 and the key sentences 163 and 164.

In FIG. 34, the generative AI system 4 determines the frame information and the terminal device 1 displays the major item and the key sentences. However, the participant may drag and drop the combination of the major item and the key sentences in the AI analysis area 104 to the whiteboard work area 102 to display the major item and the key sentences in the AI analysis area 104. In this case, the generative AI system 4 may not intervene or may reduce the intervention, and the second display control unit 17 may be able to display the major item 162 and the key sentences 163 and 164 simply surrounded by a rectangular frame. Accordingly, a delay in communication between the terminal device 1, the information processing apparatus 3, and the generative AI system 4 can be reduced.

The participant may be able to manually input characters, illustrations, and tags directly into the frame 161.

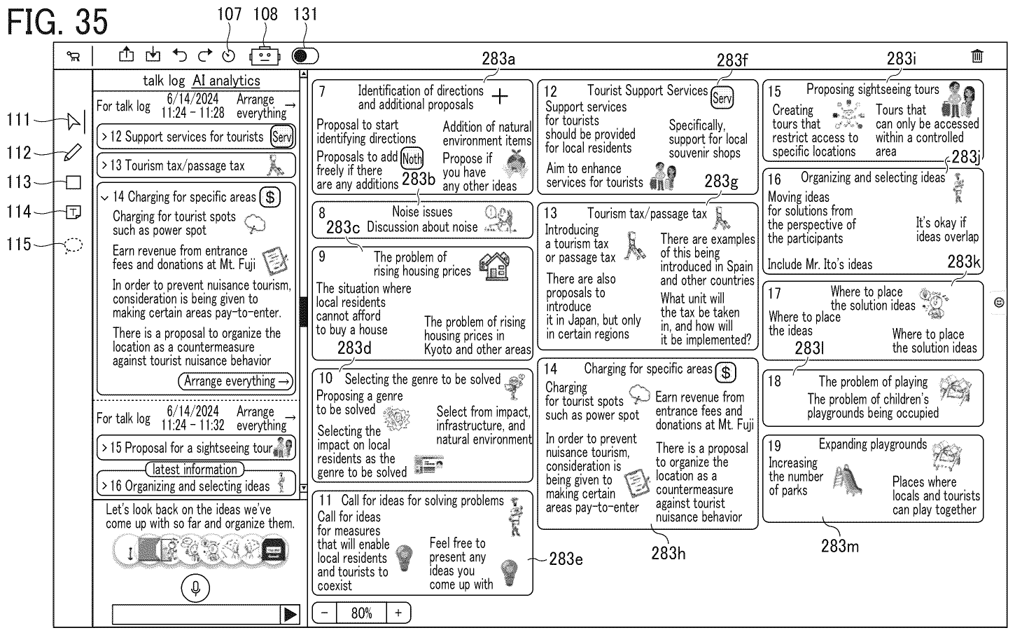

FIG. 35 is a diagram illustrating the whiteboard work area 102 in which multiple frames are displayed. In FIG. 35, thirteen frames 283a to 283m are displayed. As illustrated in FIG. 35, the participant can display the major item and the key sentences in the frame for each combination of the major item and one or more key sentences. A number 284 is displayed in each of the frames 283a to 283m. The number 284 indicates the order of the frames displayed in the whiteboard work area 102. The user can check the number 284 and sequentially view the frames 283a to 283m to grasp the flow of the discussion. In FIG. 35, the shapes of the frames 283a to 283m are the same. This is considered to be because, for example, the generative AI system 4 determines the shape of the common frame, the type of the frame line, the color of the frame, the thickness of the frame, the color in the frame, and the font based on each of the combinations of the major item and one or more key sentences.

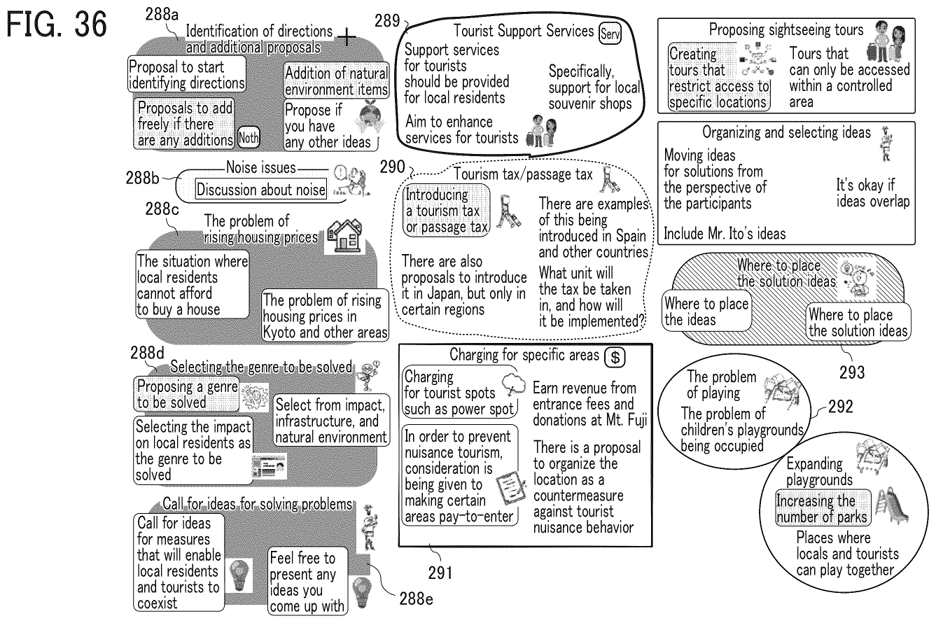

FIG. 36 is a diagram illustrating the whiteboard work area 102 in which frames are displayed in different modes according to combinations of the major item and one or more key sentences. As illustrated in FIG. 36, frames 288a to 288e have no frame line. Although the drawing is black and white, the range of the frame 288a is illustrated by coloring the inside of the frame 288a. A frame 289 has a freehand shape with a thick solid line. A frame 290 has a freehand shape with a dotted line. A frame 291 has a rectangular shape with a solid line. A frame 292 is a circle with a solid line.

The insides of the frames 288a to 288e are colored in different colors. The inside of a frame 293 is hatched. For example, the font of the frame 288d is different from the font of the frame 289. The background of the key sentence in the frame can also be colored, and the generative AI system 4 can determine the background from the content of the key sentence.

As described above, the terminal device 1 can display the major item and the key sentence in the same whiteboard work area 102 with various forms of frames (shape, type of frame line, frame color, frame thickness, color in frame, and font). The participant can easily visually grasp what content the major item and the key sentence have.

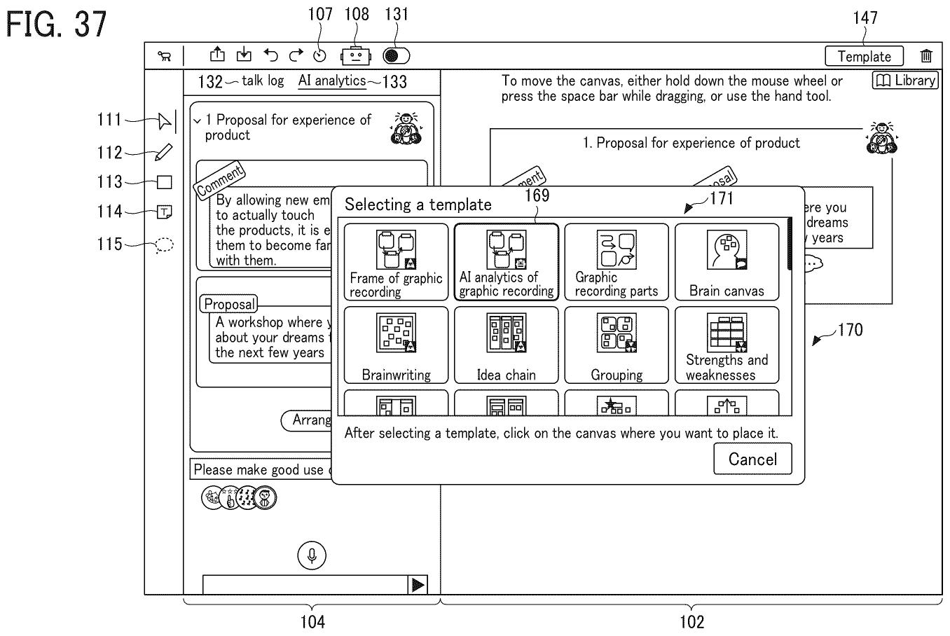

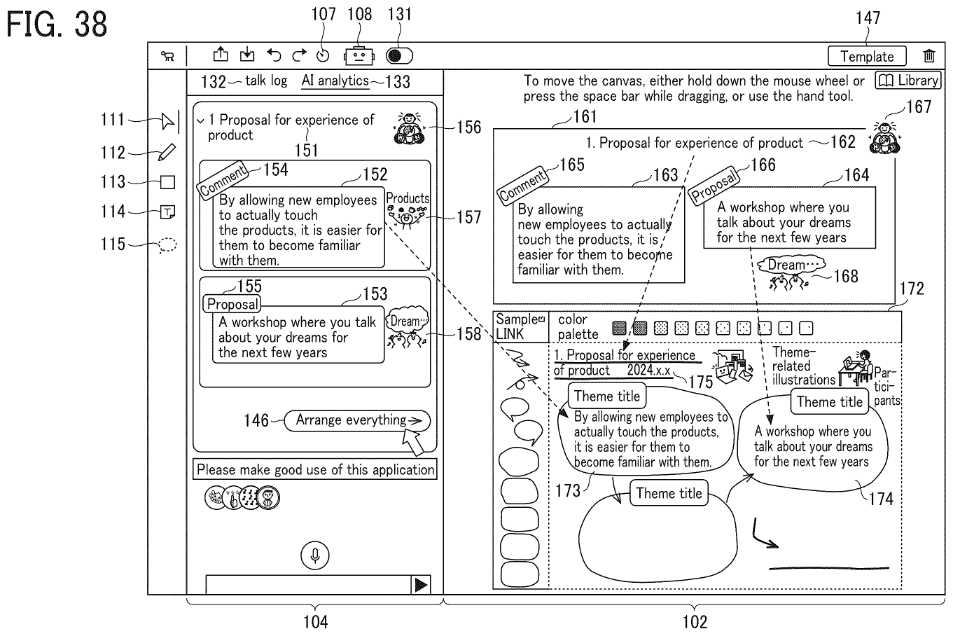

A description is given below of the content arrangement template with reference to FIGS. 37 and 38. FIG. 37 is a diagram illustrating a selection screen 170 of a content arrangement template. The content arrangement template is a tool for efficiently analyzing the content (language information) of the conference. In other words, the content arrangement template is a template of the arrangement of the major items and the key sentences, which is prepared for the purpose of grasping the tendency and characteristics of the language information, efficiently transmitting the information, and intuitively understanding the information. Any major items and key sentences are all major items and key sentences in the past displayed in the AI analysis area 104 from the start to the end of the conference. It does not matter whether the major item and the key sentence are displayed in the AI analysis area 104 or in the whiteboard work area 102.

In FIG. 37, multiple candidates for the content arrangement template 171 are displayed. The generative AI system 4 proposes one or more content arrangement templates 171 to the participant in view of the language information to date. The content arrangement template proposed by the generative AI system 4 is surrounded by a bold frame 169. Multiple content arrangement templates may be proposed. As described above, the content arrangement template 171 proposed by the generative AI system 4 is emphasized, and thus the participant can distinguish the content arrangement template 171 proposed by the generative AI system 4. The participant can use the content arrangement template surrounded by the bold frame 169 proposed by the generative AI system 4. Alternatively, the participant can select any content arrangement template from the selection screen 170 of the content arrangement template. Instead of the final selection by the participant, one content arrangement template determined by the generative AI system 4 may be displayed in the whiteboard work area 102.

The selection screen 170 of the content arrangement template is automatically displayed at a timing when the generative AI system 4 determines that an appropriate content arrangement template is available. Alternatively, the content arrangement template may be displayed at a timing when the participant inputs an operation of requesting the content arrangement template. For example, in FIG. 37, a template button 147 is displayed on the upper right of the whiteboard work area 102. When the participant presses the template button 147, the generative AI system 4 proposes an appropriate content arrangement template.

In FIG. 37, the frame 161 including the major item 162 and the key sentences 163 and 164 have already been displayed in the whiteboard work area 102, but the major item 162 and the key sentences 163 and 164 do not need to be displayed in the whiteboard work area 102 before the content arrangement template is displayed. The terminal device 1 can display the content arrangement template in a state where nothing is displayed in the whiteboard work area 102.

FIG. 38 is a diagram illustrating the content arrangement template 172 displayed in the whiteboard work area 102. The content arrangement template 172 is provided with arrangement fields 173 to 175 for dragging and dropping any major item or key sentence. The participant can drag and drop any major item and key sentence to any of the arrangement fields 173 to 175. In FIG. 38, the major item 162 is dragged and dropped in the arrangement field 175, the key sentence 164 is dragged and dropped in the arrangement field 174, and the key sentence 152 is dragged and dropped in the arrangement field 173.

Since the content arrangement template corresponding to the content of the discussion is proposed in this way, the participant can use the major item and the key sentence to effectively summarize the content of the discussion. The participant can also directly input characters in any arrangement field instead of performing the drag-and-drop operation.

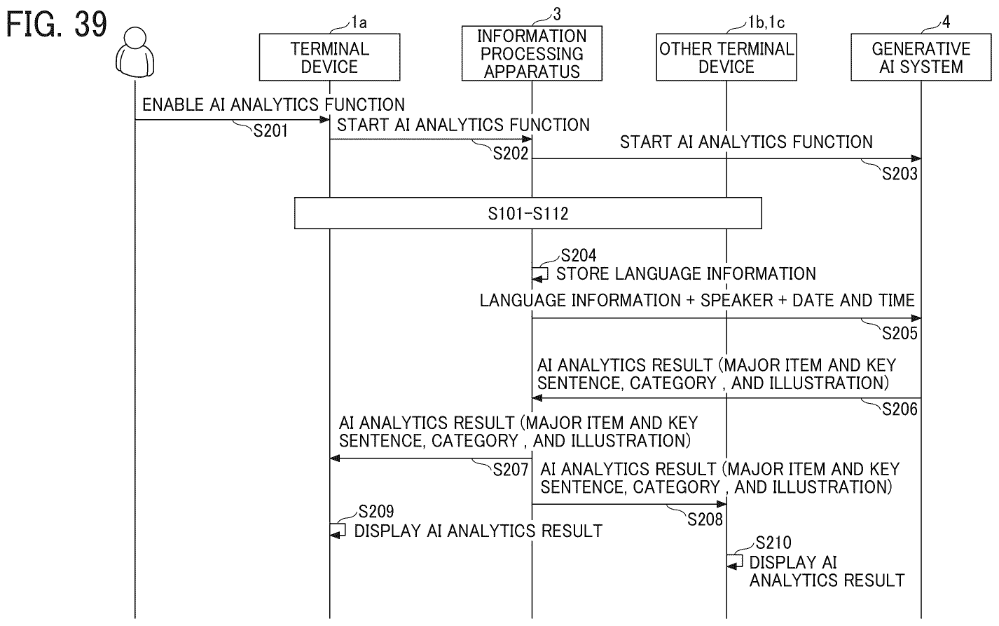

A description is given below of a processing flow in which the terminal device 1 displays the AI analysis result generated by the generative AI system 4 performing AI analysis on the language information with reference to FIG. 39. FIG. 39 is a sequence diagram illustrating a process of displaying the AI analysis result generated by analyzing the language information by the generative AI system 4 in the AI analysis area 104. A certain amount of language information has already been accumulated in the conversation accumulation area 101 by the process in FIG. 16.

In step S201, the participant operates the terminal device 1a to turn on the AI analysis function (toggle button 131). The participant also selects the tab 133. The operation reception unit 18 of the terminal device 1a receives these operations.

In step S202, since the toggle button 131 is turned on by the participant, the first communication unit 11 of the terminal device 1a transmits a request to start AI analysis to the information processing apparatus 3.

In step S203, the second communication unit 31 of the information processing apparatus 3 receives the request to start AI analysis, and the third communication unit 38 of the information processing apparatus 3 transmits the request to start AI analysis to the generative AI system 4. Accordingly, the generative AI system 4 starts to perform AI analysis on the language information already accumulated in the conversation accumulation area 101 and the subsequent language information.

After that, each participant participating in the conference speaks, and steps S101 to S112 of FIG. 16 are repeatedly executed.

In step S204, the analysis information acquisition unit 37 of the information processing apparatus 3 transmits the language information (including information of the speaker and the date and time of each language information) to the generative AI system 4. The analysis information acquisition unit 37 transmits a preferable amount of language information for AI analysis that enables analysis of the context to the generative AI system 4. For example, the analysis information acquisition unit 37 may transmit the language information to the generative AI system 4 every time a certain number of pieces of language information are accumulated.

The analysis information acquisition unit 37 may transmit all pieces of the language information from the last determination of the major item to the next determination of the major item to the generative AI system 4. In other words, the language information from the last determination of the major item to the current determination is transmitted in a duplicated manner, and in addition, new language information is transmitted. Accordingly, the generative AI system 4 can detect that the topic has changed and newly determine a major item.

The language information may be sequentially transmitted to the generative AI system 4 without being accumulated. In this case, the generative AI system 4 is assumed to have a function of accumulating language information, and the generative AI system 4 determines a change in a topic in the discussion.

In step S205, the third communication unit 38 of the information processing apparatus 3 transmits the language information, the speaker, and the date and time to the generative AI system 4 together with the request of AI analysis.

In step S206, the generative AI system 4 performs AI analysis on the language information, generates an AI analysis result, and returns the AI analysis result to the information processing apparatus 3. The AI analysis result is, for example, a major item and a key sentence, a category of the key sentence, an illustration of the major item, and an illustration of the key sentence. The analysis information acquisition unit 37 of the information processing apparatus 3 acquires the AI analysis result via the third communication unit 38.

In steps S207 and S208, the second communication unit 31 of the information processing apparatus 3 transmits the AI analysis result to the terminal devices 1a to 1c.

In steps S209 and S210, each of the first communication units 11 of the terminal devices 1a to 1c receives the AI analysis result, and each of the third display control units 22 of the terminal devices 1a to 1c displays the AI analysis result in each of the AI analysis areas 104 of the terminal devices 1a to 1c. In other words, the major item and the key sentence are displayed in the AI analysis area 104, the illustration is displayed in association with the major item, and the category and the illustration are displayed in association with the key sentence.

As described above, as illustrated in FIG. 33, the major item 151, the key sentences 152 and 153, the illustrations 157 and 158, and the categories 154 and 155 are displayed in the AI analysis area 104.

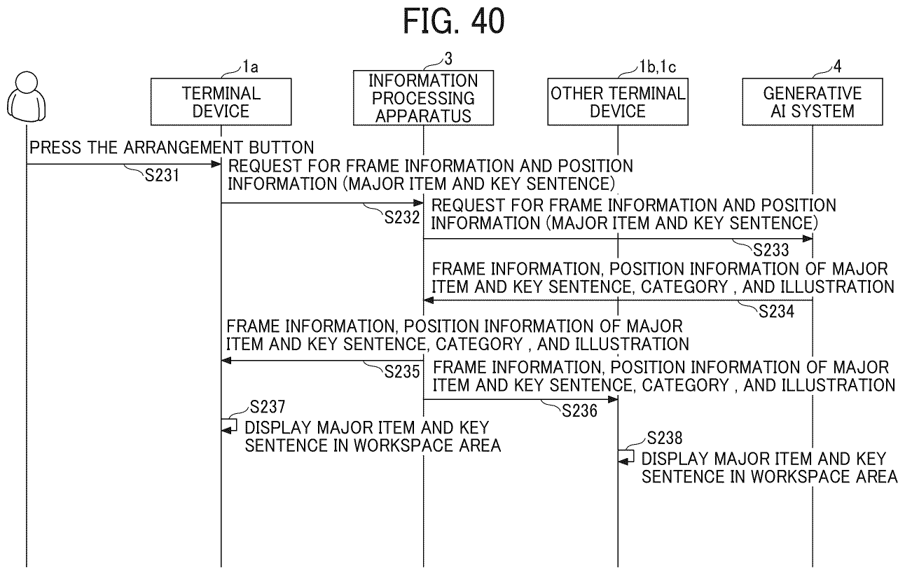

A description is given below of a processing flow for displaying the major item and the key sentences in the whiteboard work area 102 with reference to FIG. 40. FIG. 40 is a sequence diagram illustrating a process in which the terminal device 1 displays the major item and the key sentences in the whiteboard work area 102.

In step S231, the participant operates the terminal device 1a to press the arrangement button 146. The operation reception unit 18 of the terminal device 1a receives the pressing of the arrangement button 146.

In step S232, the first communication unit 11 of the terminal device 1a transmits a request for the frame information and the position information to the information processing apparatus 3 in response to the pressing of the arrangement button 146. The position information is information for arranging the major item and the key sentences in the whiteboard work area 102. Accordingly, the information transmitted to the information processing apparatus 3 includes the major item and the key sentences. Alternatively, information (ID) for designating the major item and the key sentences may be included instead of the major item and the key sentences.

In step S233, when the second communication unit 31 of the information processing apparatus 3 receives the request for the frame information and the position information, the third communication unit 38 of the information processing apparatus 3 transmits the request for the frame information and the position information to the generative AI system 4. The generative AI system 4 determines the frame information (a shape of a frame, a type of a frame line, a color of the frame, a thickness of the frame, a color in the frame, and a font) based on at least one of the major item and the key sentences. The generative AI system 4 determines the size of the frame based on the size of the major item (the size of the circumscribed rectangle), the sizes of the key sentences (the size of the circumscribed rectangle), and the number of key sentences. The generative AI system 4 determines the size of the frame that includes the frame of the major item and all frames of the key sentences. The generative AI system 4 determines the position information of the major item and determines the position information of the key sentences in the frame based on the number of key sentences. As a simple method, the generative AI system 4 determines the position information for arranging the major item at the top and arranging the key sentences in two rows in time series below the major item. The position information may be a relative position with reference to a frame having, for example, the upper left corner of the frame as the origin. Alternatively, the position information may be an absolute position indicating a position in the whiteboard work area 102. In the case of the relative position, the participant moves the frame to an empty space in the whiteboard work area 102. In the case of the absolute position, since the generative AI system 4 determines the empty space of the whiteboard work area 102, the second display control unit 17 arranges the frame based on the absolute position to display the frame in the empty space.

The generative AI system 4 determines the illustration 167 arranged on the upper right of the frame, and the illustration 167 has been determined based on the content of the major item (an illustration 156 corresponds to the illustration 167). Accordingly, the generative AI system 4 does not have to newly determine the illustration 167. In this case, the second display control unit 17 of the terminal device 1 displays the illustration 156 in the conversation accumulation area 101 on the upper right of the frame 161 in the whiteboard work area 102. The generative AI system 4 determines the illustration 168 to be displayed in association with the key sentences 163 and 164. The illustration 168 has been determined based on the content of the key sentence 164. Accordingly, the generative AI system 4 does not have to newly determine the illustration 168. In this case, the second display control unit 17 of the terminal device 1 displays the illustration 158 in the conversation accumulation area 101 around the key sentence 164 as the illustration 168.

In step S234, the generative AI system 4 returns the frame information, the position information of the major item and the key sentences, the categories, and the illustrations to the information processing apparatus 3. The analysis information acquisition unit 37 of the information processing apparatus 3 acquires these pieces of information returned by the generative AI system 4 via the third communication unit 38.

In steps S235 and S236, the second communication unit 31 of the information processing apparatus 3 transmits the frame information, the position information of the major item and the key sentences, the categories, and the illustrations to the terminal devices 1a to 1c.

In steps S237 and S238, the first communication unit 11 of each of the terminal devices 1a to 1c receives the frame information, the position information of the major item and the key sentences, the categories, and the illustrations, and the second display control unit 17 forms the frame 161 in the whiteboard work area 102 and displays the major item 162 and the key sentences 163 and 164 in the frame 161 based on the position information. The second display control unit 17 displays the illustration 167 determined based on the major item on the upper right of the frame 161, displays the category 165 in the key sentence 163, and displays the category 166 and the illustration 168 in the key sentence 164.

As described above, as illustrated in FIG. 34, the major item 162 and the key sentences 163 and 164 are displayed in the frame 161 in the whiteboard work area 102.

In the process of FIG. 40, the terminal devices 1a to 1c display the same major item and key sentences in the frame, but the major item and key sentences may be displayed in the frame only in the terminal device 1a of which the arrangement button 146 has been pressed. In other words, each participant can use the arrangement button 146 to select a major item and key sentences to be displayed in the whiteboard work area 102.

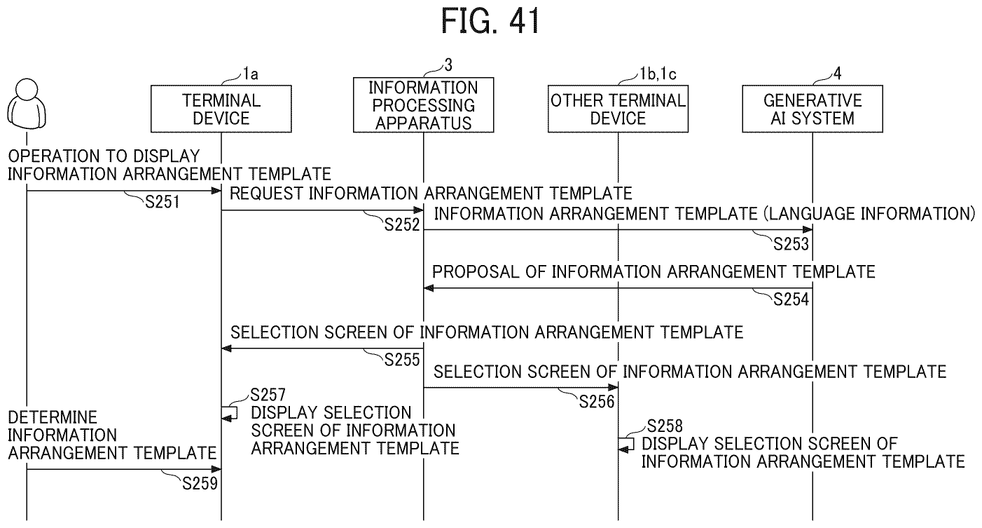

A description is given below a processing flow for displaying the content arrangement template with reference to FIG. 41. FIG. 41 is a sequence diagram illustrating the processing flow for displaying the content arrangement template by the terminal devices 1.

In step S251, the participant inputs an operation (pressing of the template button 147) for displaying the content arrangement template on the terminal device 1a. The operation reception unit 18 of the terminal device 1a receives this operation. The generative AI system 4 may determine the past language information to automatically propose the content arrangement template.

In step S252, when the template button 147 is pressed, the first communication unit 11 of the terminal device 1a transmits a request for the content arrangement template to the information processing apparatus 3.

In step S253, the second communication unit 31 of the information processing apparatus 3 receives the request for the content arrangement template, and the third communication unit 38 transmits the request for the content arrangement template to the generative AI system 4. Since the language information is used for the proposal of the content arrangement template, the information processing apparatus 3 transmits all of or at least a part of the language information accumulated in the conversation accumulation area 101 to the generative AI system 4.

In step S254, the generative AI system 4 determines one or more content arrangement templates to be proposed based on the language information. The information processing apparatus 3 may transmit all content arrangement templates to the generative AI system 4 in advance and request the generative AI system 4 to select one or more content arrangement templates to be proposed from among the content arrangement templates. The generative AI system 4 returns the proposal of the content arrangement template to the information processing apparatus 3. The proposal of the content arrangement template from the generative AI system 4 includes identification information of all selectable content arrangement templates and one or more content arrangement templates to be proposed. All selectable content arrangement templates may be stored in the information processing apparatus 3 and transmitted to the terminal device 1 together with one or more content arrangement templates proposed by the generative AI system 4.

In steps S255 and S256, the analysis information acquisition unit 37 of the information processing apparatus 3 acquires the proposal of the content arrangement template via the third communication unit 38. The second communication unit 31 of the information processing apparatus 3 transmits the screen information of the selection screen 170 of the content arrangement template to the terminal devices 1a to 1c. In the selection screen 170 of the content arrangement template, the content arrangement template proposed by the generative AI system 4 is highlighted by a bold frame.

In steps S257 and S258, the first communication unit 11 of each of the terminal devices 1a to 1c receives the screen information of the selection screen 170 of the content arrangement template, and the second display control unit 17 displays the selection screen 170 of the content arrangement template in the whiteboard work area 102.

In the process of FIG. 41, each of the terminal devices 1a to 1c displays the selection screen 170 of the content arrangement template, but only the terminal device 1a (e.g., the facilitator of the conference uses the terminal device 1a) that has requested selection screen 170 of the content arrangement template may display the selection screen 170 of the content arrangement template. As a result, the selection screen 170 of the content arrangement template is displayed as illustrated in FIG. 37.

In step S259, the participant selects a content arrangement template from the selection screen 170 of the content arrangement template. Alternatively, in a case where the generative AI system 4 determines only one content arrangement template to be proposed, the received content arrangement template is displayed even if the participant does not select the content arrangement template.

As described in FIG. 38, the participant can drag and drop any major item or key sentences to the content arrangement template to arrange the content of the discussion. Since the content arrangement template is proposed in accordance with the content of the discussion, it is expected that the participant can easily arrange the content of the discussion.

In the present embodiment, AI analysis results are displayed in real time during the conference as described above. However, the AI analysis results may be desired to be displayed after the conference is finished. For example, a usage can be performed in which each participant works in the whiteboard work area 102 during the conference, and the participants share the AI analysis results and review the content of the conference after the conference is finished.

When the participants perform AI analysis for reviewing the content of the conference after the conference is finished, at least one of the terminal device 1 and the information processing apparatus 3 accumulates language information. After the participant operates the toggle button 131 to turn on the AI analysis function, the information processing apparatus 3 transmits the language information to the generative AI system 4.

FIG. 42 is a sequence diagram illustrating a process in which the terminal device 1 displays the AI analysis result generated by the generative AI system 4 analyzing the language information in the AI analysis area 104 after the end of the conference. In the following description, mainly the differences from FIG. 39 may be described with reference to FIG. 42.

Each participant participating in the conference speaks, and steps S101 to S112 of FIG. 16 are repeatedly executed. After that, the conference is assumed to be finished. However, the AI analysis function can be turned on even in the middle of the conference.

In step S271, the participant operates the terminal device 1a to turn on the AI analysis function (toggle button 131). The participant selects the tab 133. The operation reception unit 18 of the terminal device 1a receives these operations.

In step S272, since the toggle button 131 is turned on by the participant, the first communication unit 11 of the terminal device 1a transmits a request to start AI analysis to the information processing apparatus 3.

In step S273, the second communication unit 31 of the information processing apparatus 3 receives the request to start AI analysis, and the third communication unit 38 transmits the request to start AI analysis to the generative AI system 4.

In step S274, subsequently, the second communication unit 31 of the information processing apparatus 3 transmits the language information of the entire conference stored or received from the terminal device 1 to the generative AI system 4. The second communication unit 31 may transmit all pieces of the language information to the generative AI system 4 at once or may transmit the language information to the generative AI system 4 piece by piece in the same or substantially the same manner as during the conference (see step S204).

The subsequent processing in steps S275 to S279 is performed in the same or substantially the same manner as steps S205 to S210 of FIG. 39. As described above, as illustrated in FIG. 33, the major item 151 and the key sentences 152 and 153 are displayed in the AI analysis area 104. After that, the participant can press the arrangement button 146 to display the major item 162 and the key sentences 163 and 164 in the whiteboard work area 102 or display the content arrangement template 172.

In this way, the participants can turn on the AI analysis function after the conference is finished (or during the conference) and review the content of the conference while the participants view the AI analysis results after the conference is finished. The operation for displaying the AI analysis results can be received before the start of the communication, during the communication, or after the end of the communication.

The communication system 5 according to the present embodiment can reduce the operation load of the participant operating the setting screen, in addition to the effects of the first embodiment described above.

The embodiments described above are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the present embodiment, voice data is mainly converted into language information. However, the language information may be chat (text data) input by a participant using a keyboard.

In the present embodiment, the terminal device 1 transmits language information to the information processing apparatus 3, and the information processing apparatus 3 transmits the language information to the generative AI system 4. Thus, the information processing apparatus 3 transmits the acquired analysis information to the terminal device 1. However, the terminal device 1 may transmit the language information in the designated range to the generative AI system 4 and the terminal device 1 may directly acquire the analysis information from the generative AI system 4. The terminal device 1 executes a web application or a native application, performs processing to be processed on the terminal device 1, and can display the analysis information in the whiteboard work area 102. For example, when the terminal device 1 is used at one site (when the terminal device 1 is an electronic whiteboard), the usage described above may be employed.

For example, in the present embodiment, the information display screen 100 is displayed on the display 506. However, the information display screen 100 may be displayed by a projector. In this case, the communication system 5 detects coordinates of a handwriting pen tip by ultrasonic waves. The pen emits light and transmits the ultrasonic wave, and the terminal device 1 calculates the distance from the arrival time of the ultrasonic wave. The terminal device 1 can determine the position of the pen by the direction and the distance, and the projector draws (projects) the locus of the pen as stroke data.

The number of terminal devices 1 may be one. In this case, the participant can use the terminal device 1 as a tool for organizing or recording ideas of the participant.

The configuration illustrated in, for example, FIG. 4 is divided according to main functions in order to facilitate understanding of processing by the terminal device 1 and the information processing apparatus 3. The scope of the present disclosure is not limited by how the process units are divided or by the names of the process units. The processes implemented by the terminal device 1 and the information processing apparatus 3 can be divided to a larger number of processes depending on the contents of processes. One process may be divided to include the larger number of processes.

The apparatuses or devices described in the embodiments described above are merely one example of multiple computing environments that implement the embodiments disclosed herein. In some embodiments, the information processing apparatus 3 includes multiple computing devices, such as a server cluster. The multiple computing devices are configured to communicate with one another through any type of communication link including, for example, a network or a shared memory, and perform the processes disclosed in the present specification.

The information processing system 3 can be configured to share the disclosed processing steps, for example, the processes illustrated in FIGS. 16 and 17, in various combinations. For example, a process performed by a given unit may be performed by multiple information processing apparatuses included in the information processing apparatus 3. The information processing apparatus 3 may be integrated into one server or may be divided into multiple servers.

The tables in the present specification described above may be generated by the learning effect of machine learning. In the present disclosure, the machine learning is defined as a technology that makes a computer acquire human-like learning ability. In addition, the machine learning refers to a technology in which a computer autonomously generates an algorithm required for determination such as data identification from learning data loaded in advance and applies the generated algorithm to new data to make a prediction. Any suitable learning method is applied for machine learning, for example, any one of supervised learning, unsupervised learning, semi-supervised learning, reinforcement learning, and deep learning, or a combination of two or more those learning.

A description is given below of some aspects of the present disclosure.

### Aspect 1

A communication system includes an information processing apparatus and one or more terminal devices. The information processing apparatus and the terminal device communicate with each other via a network. The terminal device includes a first display control unit and a second display control unit. The information processing apparatus includes an analysis information acquisition unit. The first display control unit displays language information based on information input to the terminal device in a first area of an information display screen of the terminal device in a time series. The analysis information acquisition unit acquires analysis information acquired by analysis of language information in a designated range among the language information based on information input to the terminal device. The second display control unit displays the analysis information acquired by the information processing apparatus in a second area of the information display screen.

### Aspect 2

In the communication system according to Aspect 1, the information processing apparatus further includes a conversion unit. The conversion unit converts voice information based on voice data input to the terminal device into the language information. The first display control unit displays the language information converted by the conversion unit in the first area.

### Aspect 3

In the communication system according to Aspects 1 or 2, the analysis information acquisition unit acquires the analysis information acquired by analysis of the language information with analysis content set in advance.

### Aspect 4

In the communication system according to Aspect 3, the analysis content set in advance is to analyze the language information and acquire one or more of a summary, a topic, or an agenda of the language information in a designated range.

### Aspect 5

In the communication system according to Aspect 3, the analysis content set in advance is to analyze the language information and acquire information acquired by diverging or converging the language information in a designated range.

### Aspect 6

In the communication system according to Aspect 3, the analysis content set in advance is information that is input by a participant of the terminal device in natural language and that designates the analysis content of the language information.

### Aspect 7

In the communication system according to any one of Aspects 3 to 6, the information processing apparatus further includes a communication unit that transmits screen information for accepting selection of the analysis content to the terminal device. The information processing apparatus receives a setting of the analysis content from the terminal device.

### Aspect 8

In the communication system according to any one of Aspects 1 to 6, the language information in the designated range is designated by a start time and an end time with respect to a time associated with the language information.

### Aspect 9

In the communication system according to any one of Aspects 1 to 6, the language information in the designated range is language information received by the information processing apparatus from the terminal device during a certain time interval.

### Aspect 10

In the communication system according to any one of Aspects 1 to 6, the language information in the designated range is the number of characters of the language information received by the information processing apparatus from the terminal device.

### Aspect 11

In the communication system according to any one of Aspects 1 to 6, the language information in the designated range is language information from when a speaker of the language information is switched last time to when the speaker is switched next time.

### Aspect 12

In the communication system according to any one of Aspects 1 to 6, the language information in the designated range is language information from when a topic of the language information is switched last time to when the topic is switched next time.

### Aspect 13

In the communication system according to any one of Aspects 8 to 12, the information processing apparatus further includes a communication unit that transmits screen information for receiving selection of a range of the language information to the terminal device. The information processing apparatus receives a setting of the range of the language information from the terminal device.

### Aspect 14

In the communication system according to any one of Aspects 1 to 13, the second display control unit included in the terminal device displays the analysis information in the second area in a display mode corresponding to a type of the analysis information.

### Aspect 15

In the communication system according to any one of Aspects 1 to 14, the second display control unit included in the terminal device highlights and displays a specific character string included in the analysis information.

### Aspect 16

In the communication system according to any one of Aspects 1 to 15, the information processing apparatus further includes an analysis information arrangement unit that determines arrangement of multiple pieces of analysis information based on arrangement information associated with a type of the analysis information when the analysis information acquisition unit acquires the multiple pieces of analysis information. The second display control unit included in the terminal device displays the analysis information in the second area based on the arrangement determined by the analysis information arrangement unit.

### Aspect 17

In the communication system according to Aspect 16, the arrangement determined by the analysis information arrangement unit includes a line connected between one piece of the analysis information and another piece of the analysis information.

### Aspect 18

In the communication system according to any one of Aspects 16 or 17, the second display control unit included in the terminal device displays the analysis information in an area set in advance by a participant in the second area.

### Aspect 19

In the communication system according to any one of Aspects 1 to 18, the terminal device further includes a search unit that acquires an illustration based on the analysis information displayed in the second area. The second display control unit included in the terminal device displays the illustration around the analysis information displayed in the second area.

### Aspect 20

In the communication system according to any one of Aspects 1 to 17, the second display control unit included in the terminal device displays the analysis information in a third area different from the first area and the second area. The second display control unit displays the analysis information in the second area when an operation of moving the analysis information selected in the third area to the second area is received.

### Aspect 21

In the communication system according to Aspect 20, the terminal device further includes a search unit that acquires an illustration based on the analysis information displayed in the third area. The second display control unit included in the terminal device displays the illustration around the analysis information displayed in the third area. The second display control unit displays the illustration in the second area when an operation of moving the illustration selected in the third area to the second area is received.

### Aspect 22

In the communication system according to Aspect 1, the analysis information acquisition unit included in the information processing apparatus acquires, as the analysis information, information generated based on an analysis result acquired by analysis of the language information based on information input to the terminal device by a generative AI system. The information processing apparatus further includes a communication unit that transmits information generated based on the analysis result to the terminal apparatus. The terminal device includes a third display control unit displays a fourth area in which information generated based on the analysis result is displayed. The third display control unit switches the display from the first area to the fourth area in response to an operation.

### Aspect 23

In the communication system according to Aspect 22, the information generated based on the analysis result includes first information serving as a subject of the language information and one or more pieces of second information extracted from the language information. One or more combinations of the first information and the one or more pieces of second information associated with the first information are displayed in the fourth area.

### Aspect 24

In the communication system according to Aspect 23, the information generated based on the analysis result includes an illustration associated with the second information. The third display control unit included in the terminal device displays the illustration associated with the second information in a one-to-one correspondence in the fourth area.

### Aspect 25

In the communication system according to Aspect 23, when an operation of displaying all of the combinations of the first information and the one or more pieces of second information associated with each other, which are displayed in the fourth area, in the second area is received, the second display control unit included in the terminal device displays the first information and the one or more pieces of second information included in the combination in the second area in a manner surrounded by a frame.

### Aspect 26

In the communication system according to Aspect 25, the terminal device transmits information indicating that the operation of displaying all of the combinations in the second area has been received, to the information processing apparatus. The analysis information acquisition unit included in the information processing apparatus designates the first information and the one or more pieces of second information included in the combination and acquires frame information including a shape of a frame from the generative AI system. The communication unit included in the information processing apparatus transmits the frame information to the terminal device. The second display control unit included in the terminal device displays the first information and the one or more pieces of second information surrounded by the frame having the shape of the frame in the second area.

### Aspect 27

In the communication system according to Aspect 26, the frame information includes one or more of a type of a frame line, a color of the frame, a thickness of the frame, a color within the frame, and a font. The second display control unit included in the terminal device performs one or more of displaying the frame by the type of the frame line, displaying the frame by the color of the frame, displaying the frame by the thickness of the frame, displaying the inside of the frame by the color inside the frame, and displaying the first information and the one or more pieces of second information by the font.

### Aspect 28

In the communication system according to Aspect 25, the terminal device transmits information indicating that an operation of displaying any template for arranging the first information and the one or more pieces of second information is received to the information processing apparatus. The analysis information acquisition unit included in the information processing apparatus designates the language information and acquires one or more candidates of the template from the generative AI system. The communication unit included in the information processing apparatus transmits one or more candidates of the template to the terminal device. The second display control unit included in the terminal device displays one or more candidates of the template in the second area and displays the template whose selection is accepted in the second area.

### Aspect 29

In the communication system according to Aspect 28, the analysis information acquisition unit included in the information processing apparatus acquires identification information of the most recommended template from the generative AI system. The communication unit included in the information processing apparatus transmits identification information of the most recommended template to the terminal device. The second display control unit included in the terminal device highlights and displays the most recommended template when the second display control unit displays the one or more candidates of the template.

### Aspect 30

In the communication system according to any one of Aspects 22 to 29, the terminal device transmits information indicating that an operation for displaying information generated based on the analysis result has been received to the information processing device. The analysis information acquisition unit included in the information processing apparatus acquires information generated based on the analysis result from the generative AI system in response to the operation. The operation for displaying information generated based on the analysis result can be received before the start of communication, during communication, or after the end of communication.

### Aspect 31

In the communication system according to Aspect 30, when the terminal device receives an operation of displaying information generated based on the analysis result after the end of communication, the terminal device transmits a notification indicating that the operation for displaying the information generated based on the analysis result has been received to the information processing device. The analysis information acquisition unit included in the information processing apparatus acquires the information generated based on the analysis result for the language information from the start to the end of the communication from the generative AI system in response to the operation. The communication unit included in the information processing apparatus transmits the information generated based on the analysis result to the terminal device. The third display control unit included in the terminal device displays the information generated based on the analysis result in the fourth area.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or DVD, and/or the memory of an FPGA or ASIC.

1. A communication system comprising:
a terminal device including terminal circuitry configured to display language information based on information input to the terminal device in a first area of an information display screen of the terminal device in a time series; and
an information processing apparatus configured to communicate with the terminal device via a network, the information processing apparatus including server circuitry configured to acquire analysis information, the analysis information including information generated by analyzing language information present in a designated range of the language information based on the information input to the terminal device,
the terminal circuitry being configured to display the analysis information acquired from the information processing apparatus in a second area of the information display screen.

2. The communication system according to claim 1,
wherein the information input to the terminal device includes voice data,
wherein the server circuitry is configured to convert voice information based on the voice data into the language information, and
wherein the terminal circuitry is configured to display the converted language information in the first area.

3. The communication system according to claim 1,
wherein the analysis information is generated by analyzing the language information in the designated range using analysis content previously set.

4. The communication system according to claim 3,
wherein the analysis content includes at least one of a summary, a topic, or an agenda of the language information in the designated range.

5. The communication system according to claim 3,
wherein the analysis content includes information acquired by diverging or converging the language information in the designated range.

6. The communication system according to claim 3,
wherein the analysis content includes information that is input by a user of the terminal device in natural language and that designates the analysis content of the language information.

7. The communication system according to claim 1,
wherein the language information in the designated range is designated by a start time and an end time obtained from information regarding a time associated with the language information.

8. The communication system according to claim 1,
wherein the language information in the designated range is language information received by the information processing apparatus from the terminal device during a certain time interval.

9. The communication system according to claim 1,
wherein the language information in the designated range includes a number of characters of the language information received by the information processing apparatus from the terminal device.

10. The communication system according to claim 1,
wherein the language information in the designated range is language information from when a speaker of the language information is switched last time to when the speaker is switched next time.

11. The communication system according to claim 1,
wherein the language information in the designated range is language information from when a topic of the language information is switched last time to when the topic is switched next time.

12. The communication system according to claim 1,
wherein the terminal circuitry is configured to display the analysis information in the second area in a display mode corresponding to a type of the analysis information.

13. The communication system according to claim 1,
wherein the terminal circuitry is configured to highlight and display a specific character string included in the analysis information.

14. The communication system according to claim 1,
wherein, when the server circuitry acquires multiple pieces of the analysis information, the server circuitry is configured to determine arrangement of the multiple pieces of the analysis information based on arrangement information associated with a type of the analysis information, and
wherein the terminal circuitry is configured to display the analysis information in the second area based on the arrangement determined by the terminal circuitry.

15. The communication system according to claim 1,
wherein the terminal circuitry is configured to acquire an illustration based on the analysis information displayed in the second area, and
wherein the terminal circuitry is configured to display the illustration around the analysis information displayed in the second area.

16. The communication system according to claim 1,
wherein the terminal circuitry is configured to display the analysis information in a third area different from the first area and the second area, and
wherein the terminal circuitry is configured to display the analysis information in the second area in response to receiving an operation of moving the analysis information selected in the third area to the second area.

17. The communication system according to claim 16,
wherein the terminal circuitry is configured to acquire an illustration based on the analysis information displayed in the third area,
display the illustration around the analysis information displayed in the third area, and
display the illustration in the second area in response to receiving an operation of moving the illustration selected in the third area to the second area.

18. The communication system according to claim 1,
wherein the analysis information includes information generated based on an analysis result acquired by analyzing the language information based on the information input to the terminal device by a generative AI system,
wherein the server circuitry is configured to transmit the information generated based on the analysis result to the terminal device,
wherein the terminal circuitry is configured to display a fourth area in which the information generated based on the analysis result is displayed, and
switch the display from the first area to the fourth area in response to an operation.

19. An information processing apparatus communicably connected with one or more terminal devices, the information processing apparatus comprising:
terminal circuitry configured to:
receive information related to language information based on information input to the terminal device;
acquire analysis information generated by analyzing the language information; and
transmit, to the terminal device, the language information to be displayed in a time series in a first area of a screen displayed by the terminal device and the analysis information to be displayed in a second area of the screen.

20. An information processing method comprising:
displaying language information based on information input to a terminal device in a first area of an information display screen of the terminal device in a time series;
with an information processing apparatus communicably connected with the terminal device,
acquiring analysis information, the analysis information including information generated by analyzing language information present in a designated range of the language information based on the information input to the terminal device; and
displaying the analysis information in a second area of the information display screen.
